(19) United States
(12) Patent Application Publication
(10) Pub. No.: US 2024/0247880 A1
(43) Pub. Date: Jul. 25, 2024

(54) MICROCHANNEL COMPACT HEAT EXCHANGING SYSTEM

(71) Applicant: King Abdulaziz University, Jeddah (SA)

(72) Inventors: Nidal Helmi ABU-HAMDEH, Jeddah (SA); Mohammad Reza SAFAEI, Miami, FL (US); Marjan GOODARZI, Beaumont, TX (US); Khalid Haza ALMITANI, Jeddah (SA); Ammar MELAIBARI, Jeddah (SA)

(73) Assignee: King Abdulaziz University, Jeddah (SA)

(21) Appl. No.: 18/158,823

(22) Filed: Jan. 24, 2023

(51) Int. Cl. F28F 1/26; B01J 19/00; C09K 5/20; F28F 23/00

(52) U.S. Cl. CPC F28F 1/26; B01J 19/0093; C09K 5/20; F28F 23/00; F24S 70/60

(57) ABSTRACT

A microchannel compact heat exchanging system is provided. The system includes a ribbed microchannel including a plurality of radial ribs and fins. A ratio between a thickness of each radial rib and a radius of the ribbed microchannel is within a first predefined range. A water-based nanofluid in the ribbed microchannel is prepared with polyethylene glycol (PEG) polymer, calcium chloride salt, and a graphene oxide carbon-based material. The system includes two plenums connected to the ribbed microchannel.

### STATEMENT OF ACKNOWLEDGEMENT

This project was funded by Knowledge Economy & Technology Transfer Center, King Abdulaziz University, Jeddah, Saudi Arabia. Grant number 2020-011.

### BACKGROUND

### Technical Field

The present disclosure is directed to a heat exchanging system, and particularly, to a compact heat exchanging system having ribbed microchannels for waste heat recovery and solar applications.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Solar power is one of the cleanest sources of energy. Solar tower technology is one of the various concentrated solar power technologies provides high solar-to-electric conversion efficiency and continuously generates solar electricity on a large scale. Solar tower technology requires a significant number of heliostats to concentrate reflected solar radiation to a solar receiver located on a top part of the solar tower. Consequently, the solar power transfers heat into fluids such as water, oil, steam, and molten salt, which drives turbines to generate electricity. An efficiency of the solar receiver is crucial to the profitability of the solar tower technology, and there is an increasing interest to design and test various types of improved receivers.

A solar air receiver uses air as a working fluid to eliminate pipe clogging and temperature limitations of conventional receivers; thus, solar air receivers have the potential to offer lower operating costs and higher efficiencies. Researchers have conducted various studies to examine performance of different solar air receivers after a conceptional design of a central tower equipped with a solar air receiver system. In addition, the performance of other types of air receivers, including solid particle receivers with single quartz tubes, ceramic foam volumetric receivers, and wire mesh receivers, were also reported by various researchers [Wang, F.; Bai, F.; Wang, T.; Li, Q.; Wang, Z. Experimental study of a single quartz tube solid particle air receiver. Solar Energy 2016, 123, 185-205; Wu, Z.; Wang, Z. Fully coupled transient modeling of ceramic foam volumetric solar air receiver. Solar Energy 2013, 89, 122-133; Wu, Z.; Caliot, C.; Flamant, G.; Wang, Z. Coupled radiation and flow modeling in ceramic foam volumetric solar air receivers. Solar Energy 2011, 85, 2374-2385].

Hasan Zahir et al. [Zahir, M. H.; Hossain, M. M.; Shafiullah, M.; Hakeem, A. S. Shape-stabilized phase change materials for energy storage based on hierarchically porous calcium magnesium carbonate. 2021] described a composite phase-change material containing a hierarchically porous Ca₁₋ₓMgₓCO₃ and having pores loaded with a phase change material. The phase change material can be polyethylene glycol. The heat storage material has a latent heat of melting 123 to 221 J/g, latent heat of freezing of 107 to 201 J/g, and thermal conductivity of 0.22 to 0.45 W/m K. Tang et al. [Tang, B.; Xiaoqiao, F.; Zhang, Y.; Lv, R.; Zhang, S. Thermal Conduction Enhanced Organic Composite Shape-stabilized Phase Change Material and Preparation Method Thereof 2020.] described a thermal conduction enhanced organic composite shape-stabilized PCM, wherein the composite shape-stabilized PCM includes coordination crosslinked network polymer, an organic solid-liquid PCM, and a thermal conduction enhancer according to the 1-50% coordination crosslinked network polymer, the 40-98.9% organic solid-liquid PCM, and the 0.1-10% thermal conductivity enhancer. Fen et al. [Xu Fen, Y. Q., Sun Lixian, Chen Dongmei, Wang Tao, Wu Yi, Zhang Huanzhi, Wei Sheng, Zhao Li. Polyethylene glycol/hydroxypropyl cellulose carbon nanotube composite solid-solid phase change material and preparation method thereof. CN110804301A, 2020] described a polyethylene glycol/hydroxypropyl cellulose carbon nanotube composite solid-solid PCM which is prepared by chemically grafting polyethylene glycol (PEG), isocyanate (MDI), and hydroxypropyl cellulose (HPC). The phase change enthalpy was 99.5-130.8 J/g, and thermal conductivity was 0.2494-0.5239 W/m K. The thermal conductivity was improved from 0.2494 W/m.K to 0.5239 W/m.K, and the utilization rate of heat was improved. Hasan Zahir et al. [Zahir, M. H.; Hossain, M. M.; Shafiullah, M.; Hakeem, A. S. Shape-stabilized phase change materials for energy storage based on hierarchically porous calcium magnesium carbonate. 2021] described a heat energy storage system that had a shape-stabilized composite of PEG/CaO containing MgCO₃. The composite had high thermal enthalpies, and their enthalpy effectiveness is substantially more than those of traditional shape stabilized phase change materials. The high heat energy storage properties and good thermal stability of such organic-inorganic composites offer utility in a range of applications, including thermal energy storage.

Zhang et al. [Zhang, W.; Zhang, X.; Xu, Y.; Xu, Y.; Qiao, J.; Shi, T.; Huang, Z.; Liu, Y. g.; Fang, M.; Min, X. Flexible polyethylene glycol/polyvinylpyrrolidone composite phase change fibres: Preparation, characterization, and thermal conductivity enhancement. Polymer 2021, 214, 123258] studied flexible polyethylene glycol/polyvinylpyrrolidone composite. The results showed that thermal conductivity of the composite fibers with carbon nanotubes was 1.71 times more than without carbon nanotubes. Chen et al. [Chen, Y.; Li, X.; Gao, J.; Yang, M.; Liu, Y.; Liu, Y.; Tang, X. Carbon layer-modified mesoporous silica supporter for PEG to improve the thermal properties of composite phase change material. Journal of Materials Science 2021, 56, 5786-5801] described carbon layer-modified mesoporous silica supporters for PEG. The results showed that the phase change enthalpy of PEG/CLMS-b enhanced from 112.0 J/g to 129.9 J/g and the thermal conductivity increased from 0.34 W/m K to 0.43 W/m K. Zheng et al. [Zheng, L.; Zhang, X.; Hua, W.; Wu, X.; Mao, F. The Effect of Hydroxylated Multi-Walled Carbon Nanotubes on the Properties of Peg-Cacl2 Form-Stable Phase Change Materials. Energies 2021, 14, 1403] described the effect of Hydroxylated MWCNT on the properties of Peg-CaCl₂. The results showed that at 1.5 wt. %, composite material exhibits the topmost phase change temperature of 42° C., and its thermal conductivity was 291.30% more than neat PEG1500 CaCl₂. Wahab et al. [Wahab, A.; Khan, M. A. Z.; Hassan, A. Impact of graphene nanofluid and phase change material on hybrid photovoltaic thermal system: Exergy analysis. Journal of Cleaner Production 2020, 277, 123370] described the effect of graphene nanofluid and PCM on the hybrid photovoltaic thermal system. The results showed that the topmost electrical and thermal exergy efficiencies resolved are 13.02% at 40 Liter per minute and 1.78% at 20 1/min with 0.1 vol. % by the hybrid photovoltaic thermal system. The highest comprehensive exergy performance was 14.62% gained by a similar system at 0.1 vol. % and 40 1/min. Manigandan et al. [Manigandan, S.; Kumar, V. Comparative study to use nanofluid ZnO and CuO with phase change material in photovoltaic thermal system. International Journal of Energy Research 2019, 43, 1882-1891] compared ZnO and CuO nanofluids with PCM in a photovoltaic thermal system. The results showed that the PVT/PCM/CuO system minted 15% high electric output in comparison to the convention module. Moreover, the inclusion of the CuO nanofluid enhanced the thermal output up to 8% for PVT and 12% for PCM without energy consumption. Lin et al. [Lin, X.; Jia, S.; Liu, J.; Li, X.; Guo, X.; Sun, W. Thermally induced flexible wood based on phase change materials for thermal energy storage and management. Journal of Materials Science 2021, 56, 16570-16581] described phase change materials for thermal energy storage. The results showed suitable phase change temperature (28.1° C. and 36.3° C.) and sufficient latent heat (64.29 J/g and 70.26 J/g) for daily applications. Thermal conductivity of the composite reached 0.417 W/m K by adding graphene, which was improved nearly by 414% compared to neat wood. Shape-stable composite PCMs for thermal energy storage were shown to have latent heats as high as 179.1 J/g, 181.9 J/g, and 132.6 J/g, for the 83.9%, 84.0%, and 74.1% weight percent of phase change materials in the achieved MA/CTW-2, PW/CTW-2, and PEG/CTW-2, individually. Further, in comparison with PW/CTW-2 and PEG/CTW-2, the gained MA/CTW-2 had better thermal management capability and exceptional thermal reliability. Hou et al. [Abdelmalek, Z.; Hussain, A.; Bilal, S.; Sherif, E.-S. M.; Thounthong, P. Brownian motion and thermophoretic diffusion influence on thermophysical aspects of electrically conducting viscoinelastic nanofluid flow over a stretched surface. Journal of Materials Research and Technology 2020, 9, 11948-11957] described thermal conductivity of copper-doped polyethylene glycol/urchin-like porous titanium dioxide PCMs. The results showed that the latent heat of the Cu/PEG/TiO₂ porous composite PCM reached 133.8 J/g, and the thermal conductivity was 0.58 W/m K, which was 152.2% more than that of TiO₂ and 38.1% more than 0.8 PEG/TiO₂. Hosseinzadeh et al. [Tesfa, B.; Mishra, R.; Zhang, C.; Gu, F.; Ball, A. Combustion and performance characteristics of CI (compression ignition) engine running with biodiesel. Energy 2013, 51, 101-115] described the impacts of ZnO/water nanofluid and the PCM on a PVT. The results showed that employing phase change material in nanofluid-based PVT system enhances output thermal exergy by 79.36%. Kiani et al. [Kiani, M.; Omiddezyani, S.; Houshfar, E.; Miremadi, S. R.; Ashjaee, M.; Nejad, A. M. Lithium-ion battery thermal management system with Al2O3/AgO/CuO nanofluids and phase change material. Applied Thermal Engineering 2020, 180, 115840] introduced a design for cooling Li-ion batteries employing active/passive techniques. The results showed that the maximum battery temperature alteration decreased by nearly 77% in copper foam with/without PCM. The results further demonstrated the imperative role of active/passive system combination that benefits both processes at the same time.

Shembekar et al. [Shembekar, A. R.; Gawthrop, P. R. Extruded microchannel heat exchanger. 2002] developed a microchannel to amend heat exchanger performance of the automotive while decreasing the designing cost, size, and weight. The microchannel with other channels are connected to drilled manifolds. The structure lets one or more fluids be cooled or heated with only one coolant. Microchannels include many channels that produce a non-uniform distribution of fluid along with the system. Also, at the channel entrance, the fluid ability is high, but during the channels, this ability drops so that the system performance decreases. These drawbacks are overcome by Lovette et al. [Lovette, J.; Zhou, P.; Shook, J. G. Multi-level microchannel heat exchangers. 2007]. The designed manifold is coupled to an interface layer. Lots of openings and exits are installed through manifold for fluid moving. The U-shaped routes are set in the interface layer. Farid et al. [Farid, M. M.; Al-Hallaj, S. Microchannel heat exchanger with micro-encapsulated phase change material for high flux cooling. 2012], developed a microchannel system in which a phase change material (PCM) is used as a refrigerant. The material enters in solid form then exits the microchannel in liquid form. The system was designed on four parts in a new microchannel structure: two tube sections specialized for collecting, a cooling flat tube section, and a fin section. The fins are placed alongside flat tubes to avoid the gas-liquid layering problem. Taras et al. [Taras, M. F.; Lifson, A. Microchannel heat exchanger with enhanced refrigerant distribution. 2011] described a microchannel design in which a distributor is utilized to conduct the coolant to communicate with distribution chambers uniformly. This feature is presented for two-phase flows, which cause some problems in manifold arrival. Abou-Ziyan et al. [Abou-Ziyan, H.; Ibrahim, M.; Abdel-Hameed, H. Characteristics enhancement of one-section and two-stepwise microchannels for cooling high-concentration multi-junction photovoltaic cells. Energy Conversion and Management 2020, 206, 112488] described a new idea on a kind of photovoltaic (PV) cells and simulated the influence of placing refrigerant fluid on the fluid flow utilizing the microchannel apparatus. The output results indicated that the new PV system has superior performance compared to the traditional PV. However, the two-stepwise microchannel system showed a more uniform temperature profile, while the one-section microchannel system had better performance. The latter system has 175.8% heat transfer coefficient higher than common systems in the literature. Sreehari et al. [Sreehari, D.; Sharma, A. K. On thermal performance of serpentine silicon microchannels. International Journal of Thermal Sciences 2019, 146, 106067] described the thermal performance of U, V, and rectangular serpentine microchannels for various Reynolds numbers and heat fluxes and described numerical modeling that indicated that microchannel with U configuration give the highest thermal performance. Boeng et al. [Boeng, J.; Rametta, R. S.; Melo, C.; Hermes, C. J. Thermal-hydraulic characterization and system-level optimization of microchannel condensers for household refrigeration applications. Thermal Science and Engineering Progress 2020, 20, 100479] numerically and experimentally analyzed a fan's effect on a microchannel used as a condenser. Two types of conditions, such as closed-loop wind tunnel and climatic chamber, were examined. Results indicated that 200 fins would be appropriate for the particular dimension of the microchannel. Li et al. [Li, Y.; Xia, G.; Ma, D.; Yang, J.; Li, W. Experimental investigation of flow boiling characteristics in microchannel with triangular cavities and rectangular fins. International Journal of Heat and Mass Transfer 2020, 148, 119036] described the influence of triangular cavities and rectangular fins on the efficiency of a microchannel. The observations showed that the new designation of microchannel would remarkably improve the heat transfer compared to the rectangular microchannel. The existence of micro fins elevated bubble departure, whereas slightly augmented pressure drop. Yagodnitsyna et al. [Yagodnitsyna, A. A.; Kovalev, A. V.; Bilsky, A. V. Ionic liquid-water flow in T-shaped microchannels with different aspect ratios. Chemical Engineering Research and Design 2020, 153, 391-400] described the fluid flow properties of a T-shaped microchannel wherein an ionic fluid-water flows through it. The investigations revealed that a bigger aspect ratio of the microchannel with a parallel flow pattern has the best performance. Furthermore, plug and bulk velocities are related to each other, while these parameters have no relation with aspect ratio. On the other hand, the aspect ratio role has appeared in velocity circulation, where the higher the aspect ratio, the lower velocity circulation.

Recently, liquid and gas cooling systems have been highly seen as one potential solution for high heat flux removal. However, such cooling systems use conventional coolants such as water or ethylene glycol, with a limited operating temperature range. Likewise, such coolants' thermal conductivity is low (e.g., 0.61 W/m K for water), inducing sizeable thermal resistance and low cooling system efficiency.

It is worth mentioning that enhancing the physical properties and promoting the cooling systems' efficiency can decrease heat exchangers' size, cooling circuits and loops, and the fabrication and operation costs. There are extensive studies conducted on the potential effect of extended areas such as fins on the heat transfer coefficient (HTC) in micro heat exchangers. However, controversial reports show that further investigation is still required to identify plausible configurations of extending areas such as ribs. The conventional heat exchangers, reactors, and cooling/heating systems require a large amount of space and active techniques such as vibration, homogenizers, and mixing systems to increase the heat and mass transfer coefficient aiming at higher efficiency. Also, heat loss to the environment is another challenge associated with the use of conventional heat exchangers. As a result, the coolants have also reached their limitations for cooling and/or heating applications. Limitation in space and the fabrication price also intensifies the challenges mentioned above, requiring a new generation of coolers/heating systems to deliver the same thermal/chemical efficiency within smaller areas and be fabricated through cheaper techniques.

The microchannel is a compact heat exchanger that significantly improves heat and mass transfer coefficient, energy efficiency, reliability, and scalability compared to conventional ones. There has been a growing interest in the application of microchannel over the few decades. As one highly efficient heat exchanger, a microchannel can also be used as a solar receiver. Nevertheless, the performance of microchannel receivers that have smaller channel sizes have not been reported.

Each of the aforementioned references suffers from one or more drawbacks hindering their adoption. Accordingly, it is one object of the present disclosure to provide microchannel compact heat exchanging systems which has higher heat transfer coefficient than conventional systems. Further, it is an object of the present disclosure to provide methods for making a phase change material with improved thermo-rheology behavior to overcome the problem of low thermal conductivity.

### SUMMARY

This disclosure presents a microchannel compact heat exchanging system. The microchannel compact heat exchanging system includes a ribbed microchannel including a plurality of radial ribs and fins. A ratio between a thickness of each radial rib and a radius of the ribbed microchannel is within a first predefined range. A water-based nanofluid in the ribbed microchannel is prepared with polyethylene glycol (PEG), calcium chloride, and a graphene oxide carbon-based material. The microchannel compact heat exchanging system includes two plenums connected to the ribbed microchannel.

In an embodiment, the first predefined range is from 5 to 10.

In an embodiment, the thickness of each radial rib is from 0.1 mm to 1 mm and the radius of the ribbed microchannel is from 0.05 mm to 0.1 mm.

In an embodiment, a length of each of the two plenums is from 0.1 m to 2 m.

In an embodiment, a distance between two adjacent radial ribs is from 0.01 mm to 0.1 mm.

In an embodiment, a number of the plurality of radial ribs is 7.

In an embodiment, the water-based nanofluid is prepared by preparing a solution by dispersing the PEG and the calcium chloride into water at 25° C. until the PEG and the calcium chloride reach saturation and by dispersing the graphene oxide carbon-based material into the solution. A volume fraction of the graphene oxide in the solution is within a second predefined range.

In an embodiment, the second predefined range is from 0.25% to 1.0%.

In an embodiment, the water-based nanofluid is stirred for a first time period and processed for a second time period using an ultrasonic signal.

In an embodiment, the first and the second time periods are from 5 mins to 60 mins.

In an embodiment, a power and a frequency of the ultrasonic signal are 400 W and 24 kHz, respectively.

In an embodiment, the water-based nanofluid is further comprises carboxymethyl cellulose.

In an embodiment, the two plenums provide a laminar fluid flow in the ribbed microchannel.

This disclosure presents a micro catalytic reactor. The micro catalytic reactor includes a ribbed microchannel including a plurality of radial ribs and fins. An internal surface of the ribbed microchannel is coated with nano-catalyst. A ratio between a thickness of each radial rib and a radius of the ribbed microchannel is within a range from 5 to 10, inclusive. The micro catalytic reactor includes two plenums connected to the ribbed microchannel.

This disclosure presents a method of preparing a water-based nanofluid. In the method, a solution is prepared by dispersing polyethylene glycol (PEG) and calcium chloride into water at 25° C. until the PEG and the calcium chloride reach saturation. A graphene oxide carbon-based material is dispersed into the solution. A volume fraction of the graphene oxide in the solution is within a predefined range.

In an embodiment, the predefined range is from 0.25% to 1.0%.

In an embodiment, the water-based nanofluid is stirred for a first time period and is processed for a second time period using an ultrasonic signal.

In an embodiment, the first and the second time periods are from 5 mins and 60 mins.

In an embodiment, a power and a frequency of the ultrasonic signal are 400 W and 24 kHz, respectively.

In an embodiment, the water-based nanofluid is prepared with carboxymethyl cellulose.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic perspective view of a ribbed microchannel of a microchannel compact heat exchanging system, according to certain embodiments;

FIG. 1B is an enlarged view of a portion of the ribbed microchannel of FIG. 1, according to certain embodiments;

FIG. 2 is a schematic flow diagram of a method of preparing a water-based nanofluid, according to certain embodiments;

FIG. 3 shows X-Ray diffraction analysis (XRD) patterns of pure polyethylene glycol (PEG), pure graphene oxide, pure CaCl₂, and composite, according to certain embodiments;

FIG. 4 shows Fourier transform infrared spectroscopy (FTIR) patterns of pure PEG, pure graphene oxide, and the composite, according to certain embodiments;

FIGS. 5A-5E show field emission scanning electron microscopy (FE-SEM) images of pure PEG, pure graphene oxide, and the composite, according to certain embodiments;

FIG. 6 shows zeta potential tests (Zeta-P) of PEG, graphene oxide, and the composite dispersed in distilled water, according to certain embodiments;

FIGS. 7A, 7B, and 7C show dynamic light scattering (DLS) values of PEG, graphene oxide, and the composite dispersed in the distilled water by intensity, number, and volume-integration, respectively, according to certain embodiments;

FIGS. 8A and 8B show heat transfer rates for PEG, graphene oxide, and the composite dispersed in water by volume fractions at different temperatures and temperatures at different volume fractions, respectively, according to certain embodiments;

FIG. 9 shows a three-dimensional (3D) graph of heat transfer rate, according to certain embodiments;

FIGS. 10A, 10B, 10C, and 10D show differential scanning calorimetry (DSC), differential thermal analysis (DTA), thermogravimetric analysis (TGA), and heat capacity (Cp) plots, respectively, for the pure PEG, pure graphene oxide, and the composite, according to certain embodiments;

FIGS. 11A-11D show viscosity and shear stress values against shear rate for different mass fractions and temperatures, according to certain embodiments;

FIG. 12 shows a 3D graph of rheological behavior for 12.23 and 122.3 s⁻¹ shear rates, according to certain embodiments;

FIG. 13 shows variations of heat transfer coefficient (HTC) with respect to number of grids, according to certain embodiments;

FIG. 14 shows a comparison between a prior art (conducted by Aminossadati et al.) and present work results, for Reynolds number (Re)=10 and 100, according to certain embodiments;

FIGS. 15A, 15B, and 15C show variations of calculated HTC with respect to Reynolds number at W/R ratios 5, 7.5, and 10, respectively, for water and nanofluids (NFs) with concentrations of 2% and 4%, according to certain embodiments;

FIGS. 16A, 16B, and 16C show variations of the temperature difference with respect to the Reynolds number for water and NFs with concentrations of 2% and 4%, at W/R=5, W/R=7.5, and W/R=10, respectively, according to certain embodiments;

FIGS. 17A, 17B, and 17C show variations of the calculated pressure drop (PD) values with respect to Reynolds number for water and NFs with concentrations of 2% and 4%, at W/R=5, W/R=7.5, and W/R=10, respectively, according to certain embodiments;

FIGS. 18A, 18B, and 18C show calculated pumping powers with respect to Reynolds numbers for water and NFs with concentrations of 2% and 4%, at W/R=5, W/R=7.5, and W/R=10, respectively, according to certain embodiments;

FIGS. 19A, 19B, 19C, and 19D show variations of HTC, temperature difference, the PD value, and the pumping power, respectively, with respect to Reynolds number for NF with concentration of 4%, according to certain embodiments; and

FIGS. 20A, 20B, and 20C show spatial temperature, pressure, and velocity profiles, respectively, across the ribbed microchannel obtained with multiphase mixture model at Re=25 for NF with concentration of 4%, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

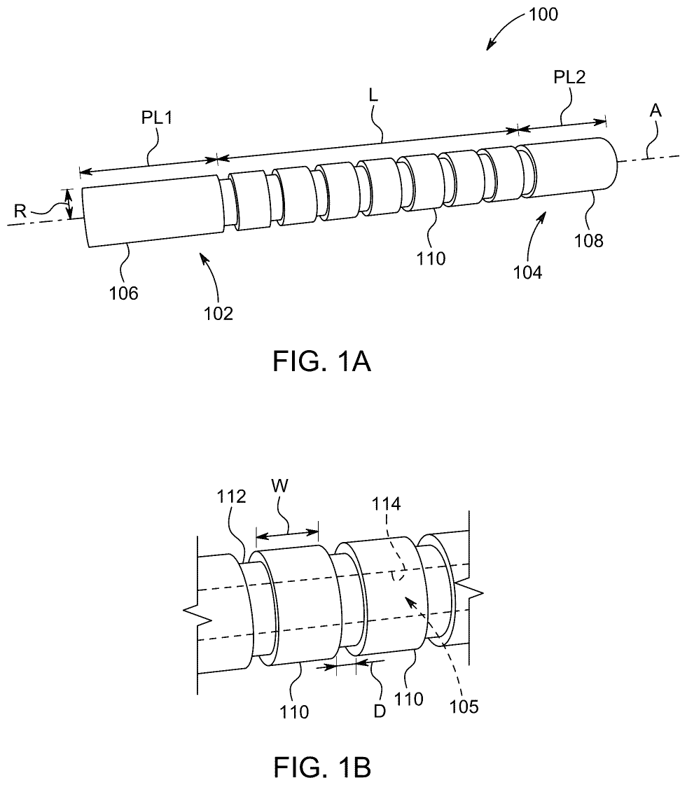

Referring to FIG. 1A, a schematic perspective view of a ribbed microchannel 100 is illustrated, according to certain embodiments of the present disclosure. One or more such ribbed microchannels 100 can constitute a microchannel compact heat exchanging system (not shown). The ribbed microchannel 100 includes a first end 102 and a second end 104 defining a length L therebetween along a longitudinal axis A. In some embodiments, the ribbed microchannel 100 is a hollow cylindrical body having a circular cross-section and a radius R. In some embodiments, a cross-sectional shape of the ribbed microchannel 100 can be an elliptical, an oval, or any other polygon shape known in the art. The ribbed microchannel 100 includes a passage 105 (shown in FIG. 1B) defined along the longitudinal axis A thereof to allow flow of fluid therethrough.

The microchannel compact heat exchanging system includes two plenums, referred to as a first plenum 106 and a second plenum 108, which are connected to the first end 102 and the second end 104, respectively, of the ribbed microchannel 100. The ribbed microchannel 100, the first plenum 106 connected to the first end 102 of the ribbed microchannel 100, and the second plenum 108 connected to the second end 104 of the ribbed microchannel 100 together define a total length of the ribbed microchannel 100 (PL1+PL2+L=total length). The first plenum 106 and the second plenum 108 have a first length PL1 and a second length PL2, respectively. Further, each of the first plenum 106 and the second plenum 108 can have a passage configured to fluidly communicate with the passage 105 of the ribbed microchannel 100.

In an embodiment, the length of each of the two plenums 106 and 108 can be from 0.1 millimeter (mm) to 2 mm.

In an embodiment, the first length PL1 of the first plenum 106 and the second length PL2 of the second plenum 108 can be identical. For example, each of the first length PL1 and the second length PL2 is around 1 mm.

In an embodiment, the first length PL1 of the first plenum 106 and the second length PL2 of the second plenum 108 can be different.

In an embodiment, the length of the ribbed microchannel 100 is around 3.9 mm.

Referring to FIG. 1B, an enlarged view of a portion of the ribbed microchannel 100 of FIG. 1 is illustrated. The ribbed microchannel 100 includes a plurality of radial ribs 110 and fins defined across the length L thereof.

In an embodiment, the ribbed microchannel 100 can include 7 radial ribs 110.

In an embodiment, each radial rib 110 has a thickness W defined along the longitudinal axis A of the ribbed microchannel 100. For example, the thickness W can be from 0.1 millimeter (mm) to 1 mm, preferably from 0.3 to 0.6 mm or about 0.5 mm.

In an embodiment, the radius R of the ribbed microchannel 100 can be from 0.05 mm to 1.0 mm, preferably from 0.05 to 0.1 mm or about 0.25 mm.

A ratio (W/R) between the thickness W of each radial rib 110 and the radius R of the ribbed microchannel 100 can be within a first predefined range. For example, the first predefined range can be from 5 to 10, inclusive. In another example, the first predefined range can be from 6 to 8. In another example, the first predefined range can be about 7.

In an embodiment, each of outer diameters of the first plenum 106 and the second plenum 108 can be identical to an outer diameter of the ribbed microchannel 100 defined by the radial ribs 110.

In an embodiment, the outer diameters of the first and second plenums 106, 108 and the outer diameter of the ribbed microchannel 100 can be different. The first plenum 106 and the second plenum 108 can provide a laminar fluid flow in the ribbed microchannel 100.

According to aspects of the disclosure, the W/R ratio can be further defined as a ratio of a width of an obstacle to the radius R of the ribbed microchannel 100, preferably 5, 7.5, or 10, for the W/R ratio. In an example, the W/R ratio can be 6, 7, 8 or 9. In another example, the W/R ratio can be 5.5, 6.5, 8.5, or 9.5.

In an embodiment, as shown in FIG. 1B, a distance D between two adjacent radial ribs is from 0.01 mm to 0.1 mm. For example, the distance D can be around 0.05 mm.

### EXAMPLES

In the examples described later herein, flow of fluid was fully developed at an inlet of the ribbed microchannel 100. Therefore, four Reynolds numbers of 10, 25, 50, and 100 were considered. The radius R of the ribbed microchannel 100 was changed continuously, so the W/R ratio changed, and the sensitivity of results to W/R ratio was evaluated. The constant heat flux of 10,000 W/m² was applied on a surface of the ribbed microchannel 100 and the radial ribs 110.

In an embodiment, the thickness W of each radial rib 110 is 0.5 mm and the radius R of the ribbed microchannel 100 is one of 0.05 mm, 0.0667 mm, and 0.1 mm. The plurality of radial ribs 110 is defined on an out surface 112 of the ribbed microchannel 100 at equal distance.

In an embodiment, the distance D defined between two adjacent radial ribs 110 is 0.05 mm.

According to aspects of the disclosure, the microchannel compact heat exchanging system can include a water-based nanofluid in the ribbed microchannel 100. The water-based nanofluid contains nanometer-sized particles (nanoparticles or NPs) such as a graphene oxide carbon-based material, which for example can have a size of 1 nm to 100 nm, preferably 10-50 nm or 20-40 nm. The water-based nanofluid can be prepared with polyethylene glycol (PEG) polymer, calcium chloride salt, and the graphene oxide carbon-based material. The water-based nanofluid can be further prepared with carboxymethyl cellulose. The polyethylene glycol 2000 polymer, the calcium chloride salt, the graphene oxide carbon-based material, and the carboxymethyl cellulose are known elements. The water solubility of the calcium chloride salt was 74.5 g/100 ml (20° C.) in an embodiment. Also, thermal conductivity (TC) of standard PEG 2000 at 25° C. (298.15 K) is 0.31 W/m K, and specific heat capacity (Cp) of standard PEG 2000 at 20° C. is 3116.07 J/mol K.

In an embodiment, the water-based nanofluid can be prepared by first preparing a solution by dispersing the PEG polymer and the calcium chloride salt into water at 25° C. until the PEG polymer and the calcium chloride salt reach saturation. Further, the graphene oxide carbon-based material can be dispersed into the solution. A volume fraction of the graphene oxide carbon-based material can be the solution is within a second predefined range. For example, the second predefined range can be from 0.25% to 1.0%, inclusive.

To prepare the water-based nanofluid, the PEG polymer and the calcium chloride salt are preferably dispersed into water at 25° C. (room temperature) until they reach saturation. For example, in 50 cc water, 25 gr PEG and 40 gr salt were dissolved. Graphene oxide was dispersed in the resulting solution with a volume fraction from 0.25% to 1.0%.

Four samples were made and the samples were put into a water bath to measure their thermal conductivity and viscosity at different temperatures. To form a composite dispersion, magnetic stirring, pH meter, sonication, and CMC were selected. To break agglomerations between nanoparticles (NPs), after 30 minutes of stirring, for suspensions, 10 minutes ultrasonic processor 400 W/24 kHz was employed. After that, a stable suspension was made to be examined.

X-Ray diffraction analysis (XRD) test was conducted by PHILIPS-PW1730. Fourier transform infrared spectroscopy (FTIR) test was recorded on BRUKER-ALPHA II. Field emission scanning electron microscopy (FESEM) observation was conducted by TESCAN-MIRA3. Zeta potential (ZP) test was conducted by HORIBA-SZ100. Dynamic light scattering (DLS) test was conducted by CORDOUAN TECHNOLOGIES-VASCO. Differential scanning calorimetry (DSC), differential thermal analysis (DTA), and thermogravimetric analysis (TGA) tests were conducted by PerkinElmer. Thermal conductivity (TC) was measured by KD2Pro (KS1 single needle, stainless steel, the sensor is used). Also, viscosity (VIS) was measured by DV2EXTRAPro (the ULA spindle, 1-200 RPM/1-6 mPa·s, is used).

In an embodiment, the water-based nanofluid can be first stirred for a first time period. The first time period can be from 5 minutes (mins) to 60 mins. For example, the first time period can 30 mins. The water-based nanofluid can be further processed for a second time period using an ultrasonic signal for example. The first time period can be from 5 minutes (mins) to 60 mins preferably from 10 to 20 minutes. For example, the second time period is 10 minutes. In an example, a power and a frequency of the ultrasonic signal can be 400 W and 24 kHz, respectively.

In an embodiment, the water-based nanofluid can be further prepared with carboxymethyl cellulose.

Following equations were used to solve a model of the ribbed microchannel 100 shown in FIG. 1A using multiphase mixture model, which developed results for spatial temperature gradient, pressure, and velocity profiles inside the ribbed microchannel 100 equipped with the radial ribs 110. Using three-dimensional modeling, the following governing equations of the problem include continuity, momentum energy, and mass flow rate.

### Continuity Equation:

$$\frac{\partial }{\partial t} ( {ρ}_{m} ) + ∇ \cdot ( {ρ}_{m} {\vec{V}}_{m} ) = 0 \qquad ( 1 )$$

$$where$$

$${\vec{V}}_{m} = \frac{{\sum }_{Z = 1}^{n} {φ}_{Z} {ρ}_{Z} {\vec{V}}_{Z}}{{ρ}_{m}} = {V}_{Z} \qquad ( 2 )$$

$$and$$

$${ρ}_{m} = {\sum }_{Z = 1}^{n} {φ}_{Z} {ρ}_{Z} \qquad ( 3 )$$

### Momentum Equation:

$$\frac{\partial }{\partial t} ( {ρ}_{m} {\vec{V}}_{m} ) + ∇ \cdot ( {ρ}_{m} {\vec{V}}_{m} {\vec{V}}_{m} ) = - ∇ {P}_{m} + ∇ \cdot [ {μ}_{m} ( ∇ {\vec{V}}_{m} + ∇ {\vec{V}}_{m}^{T} ) ] \qquad ( 4 )$$

$$where$$

$${μ}_{m} = {\sum }_{Z = 1}^{n} {φ}_{Z} {μ}_{Z} \qquad ( 5 )$$

### Energy Equation:

$$\frac{\partial }{\partial t} {ρ}_{m} {h}_{m} + ∇ \cdot ( {ρ}_{m} {h}_{m} {\vec{V}}_{m} ) + ∇ \cdot ( P {\vec{V}}_{m} ) = ∇ \cdot ( {k}_{m} ∇ T ) \qquad ( 6 )$$

$$where$$

$${ρ}_{m} {h}_{m} = {\sum }_{Z = 1}^{n} ( {φ}_{Z} {ρ}_{Z} {h}_{Z} ) \qquad ( 7 )$$

$$and$$

$${k}_{m} = {\sum }_{Z = 1}^{n} {φ}_{Z} ( {k}_{Z} ) \qquad ( 8 )$$

Nusselt number is a dimensionless number and critical criterion for assessing the heat transfer rate and performance of the ribbed microchannel 100, which is calculated using the following equation:

$$N u = \frac{{q}^{″} {D}_{h}}{{k}_{f} ( {T}_{w} - {T}_{m} )} \qquad ( 9 )$$

Here, T_{W} and Tₘ denote wall and average bulk temperatures, respectively, of the ribbed microchannel 100.

The average and the local convective coefficient can be obtained using the following equations:

$${h}_{y} = \frac{- {k}_{nf} \frac{\partial T}{\partial x} \vert x = 0}{Δ T} \qquad ( 10 )$$

$$\begin{matrix}{h}_{a v e} = \frac{1}{L} {\int }_{0}^{L} {h}_{y} & dy\end{matrix} \qquad ( 11 )$$

The fluid flow in the ribbed microchannel 100 is laminar, and the Reynolds number is low due to a small hydraulic diameter and space available in micro-passages. In the ribbed microchannels with micro-fins, when fluid hits the fins, a reversed flow is formed behind the obstacles adjacent to walls of the micro-fins, leading to a flow separation. It has been demonstrated that with increasing flow rate, the vortices start to rotate around a stable point, such as those seen in the reversed flow behind the cylinder of fins in the ribbed microchannels 100. In this case, the flow is still laminar. However, by increasing the fluid flow, the periodic disturbances become unstable. Hence, more but smaller vortices are formed. Another parameter in the experiments is pumping power, defined with the following equation:

$$P P = {u}_{i n} {A}_{c} Δ P \qquad ( 12 )$$

Using equation 6, the hydraulic diameter of the ribbed microchannel 100 can be calculated as:

$${D}_{h} = \frac{4 {A}_{c}}{p} \qquad ( 13 )$$

The variables in Equations (1)-(13) are illustrated in Table 0.1.

TABLE 1
Nomenclature

| | |
|---|---|
| A | Surface area (m²) |
| h | Heat transfer coefficient (W/m² K) |
| k | Thermal conductivity (W/m K) |
| P | Pressure (Pa) |
| q* | Constant heat flux (W) |
| Dₕ | Hydraulic Diameter (m) |
| T | Temperature (K) |
| t | Time (s) |
| h | sensible enthalpy (J/kg) |
| V | Velocity (m/s) |

Greek symbol

| | |
|---|---|
| μ_{eff} | Effective dynamic viscosity (Pa s) |
| ρ | Density (Kg/m³) |
| Φ | Nanoparticle volume fraction |

Subscripts

| | |
|---|---|
| m | Mixture |
| w | Wall |
| z | Indices |

Physical properties of the working fluid are crucial in estimating the heat transfer coefficient (HTC) and fluid properties such as friction forces and the pressure drop (PD).

The present disclosure provides a micro catalytic reactor. Referring to FIGS. 1A and 1, the micro catalytic reactor includes the ribbed microchannel 100 including the plurality of radial ribs 110 and the fins. The ribbed microchannel 100 has an internal surface 114 defining the passage 105. The internal surface 114 of the ribbed microchannel 100 is coated with nano-catalyst. Further, the ratio between the thickness W of each radial rib 110 and the radius R of the ribbed microchannel 100 is defined within the range from 5 to 10, inclusive. The micro catalytic reactor includes the two plenums such as the first plenum 106 and the second plenum 108 connected to the first end 102 and the second end 104, respectively, of the ribbed microchannel 100.

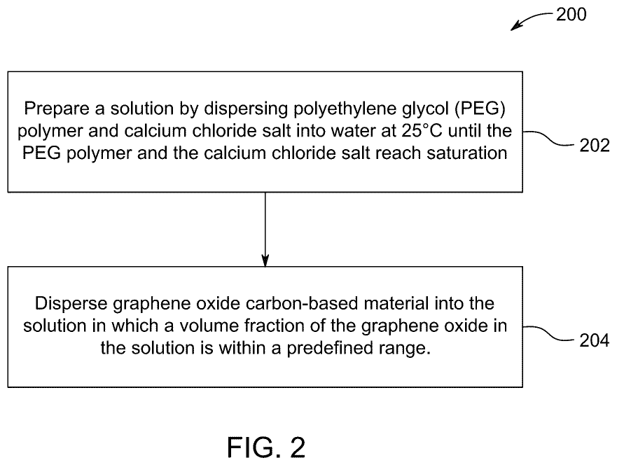

Referring to FIG. 2, a schematic flow chart of a method 200 of preparing the water-based nanofluid is illustrated, according to certain embodiments. The order in which the method 200 is described is not intended to be construed as a limitation, and any number of the described method steps can be combined in any order to implement the method 200. Additionally, individual steps may be deleted from the method 200 without departing from the spirit and scope of the present disclosure.

At step 202, the method 200 includes preparing the solution by dispersing the polyethylene glycol (PEG) polymer and the calcium chloride salt into the water at 25° C. until the PEG polymer and the calcium chloride salt reach saturation. In an embodiment, in 50 cc water, 25 gr PEG and 40 gr salt are dissolved.

At step 204, the method 200 includes dispersing the graphene oxide carbon-based material into the solution. The volume fraction of the graphene oxide mixed with the solution is within a predefined range, which is alternatively referred to as the second predefined range. In an embodiment, the predefined range is from 0.25% to 1.0%, inclusive. In an embodiment, the method 200 includes stirring the water-based nanofluid for the first time period and processing the water-based nanofluid for the second time period using the ultrasonic signal. In an embodiment, the first time period and the second time period are 30 minutes and 10 minutes, respectively. In an embodiment, the power and the frequency of the ultrasonic signal are 400 W and 24 kHz, respectively.

In an embodiment, the method 200 includes preparing the water-based nanofluid with carboxymethyl cellulose.

In the experiments, polyethylene glycol 2000 polymer, calcium chloride salt, graphene oxide carbon-based material, and carboxymethyl cellulose were mixed and dispersed in water to produce the water-based nanofluid. Various tests including X-Ray Diffraction Analysis (XRD), Fourier Transform Infrared Spectroscopy (FTIR), and Field Emission Scanning Electron Microscopy (FESEM), were conducted on raw materials. After the preparation of the water-based nanofluid, nanofluid stability was tested using Dynamic Light Scattering (DLS) and Zeta Potential (ZP) tests. In addition, differential scanning calorimetry (DSC), Differential Thermal Analysis (DTA), Thermogravimetric analysis (TGA), Thermal Conductivity (TC), Viscosity (VIS) tests also were conducted to measure the thermophysical properties of the water-based nanofluid.

Further, laminar flow and heat transfer characteristics of the water-based nanofluid (NF) in a three-dimensional micro heat exchanger with internal radial baffles were numerically investigated. A uniform and constant heat flux were applied to the heat exchanger walls at various ratios between the radius of the radial rib 110 and the radius of the ribbed microchannel 100, including 5, 7.5, and 10. The concentration of NFs varied from 0% (distilled water), 2%, and 4% at four different Reynolds numbers within 10 to 100.

To simulate the effect of nanoparticles, a homogeneous multiphase mixture model was employed. Convective heat transfer coefficient (HTC), pressure drop (PD), the temperature difference between inlet and outlet of the microchannel heat exchanger were calculated to analyze the heat and fluid flow behavior of the NF.

It is noted that utilizing an accurate and optimum ratio of the thickness W of the radial rib 110 to the radius R of the ribbed microchannel 100 (referred to as the W/R ratio) can offer a potential to change a flow regime by adding vortices next to the obstacles, causing local agitation and an increase in the convective HTC. Further, at a larger W/R ratio, the convective heat transfer can be increased. Decreasing the W/R ratio can decrease the pumping power required for circulating the NF, which can vigorously promote the economic viability of the design of the ribbed microchannel 100. Accordingly, increasing the W/R ratio parameter, Reynolds number, and the volume fraction of the nanoparticles dispersed in the base fluid can promote the heat transfer within the micro heat exchanger at the cost of augmentation in the pumping power.

With the utilization of the ribbed microchannel 100 of the present disclosure, a size of the microchannel compact heat exchanging system can be reduced to a micro-scale level, hence, surface-to-volume ratio can be anomalously increased, which is a crucial parameter for cooling/heating systems. The radial ribs 110 in the ribbed microchannel 100 can be helpful of renewing thermal and fluid dynamic boundary layer; hence, a lowest pressure drop and a significant heat transfer coefficient in the laminar flow can be achieved. Particularly, the surface forces and molecular effects become essential in the ribbed microchannel 100 in the micro-scale, thereby intensify the heat and mass transfer. Phenomena, such as thermophoresis effect or Brownian motion or catalytic effect of the fabrication material, can be enormously influential in the micro-scale size.

The microchannel compact heat exchanging system and the micro catalytic reactor provided in the present disclosure can have 3-4 times larger heat transfer coefficient than other related systems. The microchannel compact heat exchanging system is compact and can be fabricated with a computerized numerical control method and milling (machining) systems. The microfabrication of the heat exchangers can be totally implemented with mechanical operations and does not require any chemical treatment. The microchannel compact heat exchanging system can be used as a reactor for waste heat recovery in solar receivers, heat exchanger at high temperatures using liquid metals as a coolant, and can also be used for thermal energy recovery in automobile systems. Further, combining the features of the water-based nanofluid and extended area, a higher HTC and a better fluid feature can be obtained.

According to the present disclosure, the method 200, can overcome the problem of low thermal conductivity by making a phase change material with improved thermo-rheology behavior. A phase change material (PCM) composition is useful in thermal energy storage, and the method 200 for forming the material is disclosed herein. Thereof, a composite phase change material comprising polyethylene glycol polymer, graphene oxide, and calcium chloride salt, wherein the volume fraction of the graphene oxide is up to 1.00%. Phase-structural analysis and morphology observation were conducted. Also, nanofluid stability and particle size were measured. After that, the specific heat capacity was calculated. Thermal conductivity was examined for 0.25, 0.50, 0.75, and 1.00 Vol. % (volume fraction) at 30, 35, 40, 45, and 50° C. Viscosity was examined for 0.25, 0.50, 0.75, and 1.00 Vol. % at 30, 35, 40, 45, and 50° C. in 12.23, 24.46, 36.69, 61.15, 73.38, and 122.3 s⁻¹.

Using experimental results, the phase change material can be evaluated in the ribbed microchannel 100 using multiphase nanofluid (NF) flow. The ribbed microchannel 100 is equipped with the radial ribs 110 and obstacles. Accordingly, convective heat transfer of NF was studied inside the ribbed microchannel 100 using the multiphase mixture model. Further, the effects of operating conditions such as Reynolds numbers, concentrations of NFs, and the ratio of the thickness W of the radial ribs 110 to the radius R of the ribbed microchannel 100 on the heat transfer enhancement were studied. Accordingly, the models were studied in constant applied heat flux both on walls and the radial ribs 110 in steady-state conditions. The study can contribute to efficient and cost-effective design and help to develop a understanding of fluid flow and heat transfer regime in the ribbed microchannel 100.

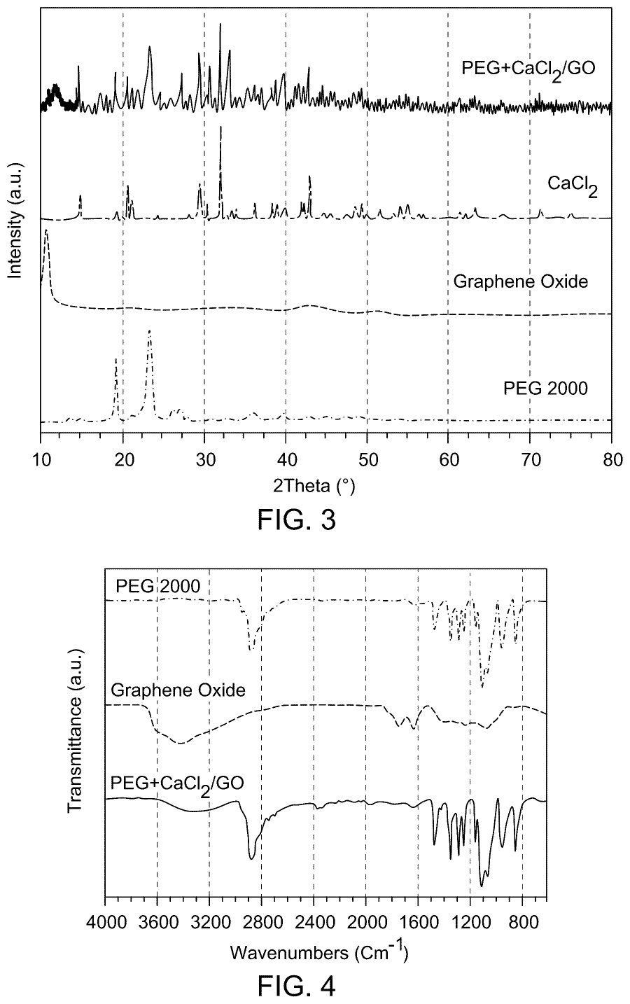

Referring to FIG. 3, the XRD patterns for materials and the composite used in the present disclosure are shown. For PEG, the characteristic peaks are at 2Theta degrees and d-lattice spacing of 13.615° with 6.5018 A, 19.211° with 4.6203 A, 23.506° with 3.7849 A, 26.209° with 3.4003 A, 27.234° with 3.2746 A, and 39.694° with 2.2707 A. For graphene oxide, the characteristic peaks are at 2Theta degrees and d-lattice spacing of 10.758° with 8.2236 A, and 42.387° with 2.1325 A. For calcium chloride, the characteristic peaks are at 2Theta degrees and d-lattice spacing of 14.764° with 6.0003 A, 20.674° with 4.2963 A, 21.179° with 4.1949 A, 29.472° with 3.0308 A, 30.457° with 2.9351 A, 32.083° with 2.7899 A, 42.946° with 2.1060 A, and 54.997° with 1.6697 A. For the composite, the characteristic peaks are at 2Theta degrees and d-lattice spacing of 14.557° with 6.0852 A, 17.328° with 5.1177 A, 19.140° with 4.6371 A, 21.770° with 4.0824 A, 23.392° with 3.8029 A, 27.237° with 3.2742 A, 29.367° with 3.0414 A, 30.756° with 2.9071 A, 31.975° with 2.7990 A, 33.105° with 2.7061 A, 38.525° with 2.3369 A, 39.812° with 2.2642 A, 41.402° with 2.1809 A, and 42.835° with 2.1112 A. Thus, formation of the composite is approved.

FIG. 4 shows the FTIR patterns for the materials and the composite used in the present disclosure. For PEG, the characteristic peaks are at wavenumber of 2876.42 Cm⁻¹ (C—H stretching), 1625.83 Cm⁻¹, 1463.45 Cm⁻¹ (C—H bending), 1338.54 Cm⁻¹ (C—H bending), 1277.49 Cm⁻¹ (O—H stretching), 1237.50 Cm⁻¹, 1145.43 Cm⁻¹, 1097.93 Cm⁻¹ (C—O—H stretching), 1056.54 Cm⁻¹, 944.93 Cm⁻¹, and 837.32 Cm⁻¹. For graphene oxide, the characteristic peaks are at wavenumbers of 3419.17 Cm⁻¹ (O—H), 1738.51 Cm⁻¹ (C═O), 1623.77 Cm⁻¹ (C═C), 1226.5 Cm⁻¹ (C—OH), and 1055.84 Cm⁻¹ (C—O). For the composite, the characteristic peaks are at wavenumber of 3348.52 Cm⁻¹, 2875.99 Cm⁻¹, 1464.86 Cm⁻¹, 1358.03 Cm⁻¹, 1340.01 Cm⁻¹, 1277.96 Cm⁻¹, 1238.20 Cm⁻¹, 1145.63 Cm⁻¹, 1098.74 Cm⁻¹, 1057.78 Cm⁻¹, 944.15 Cm⁻¹, and 839.27 Cm⁻¹. Thus, formation of the composite is approved.

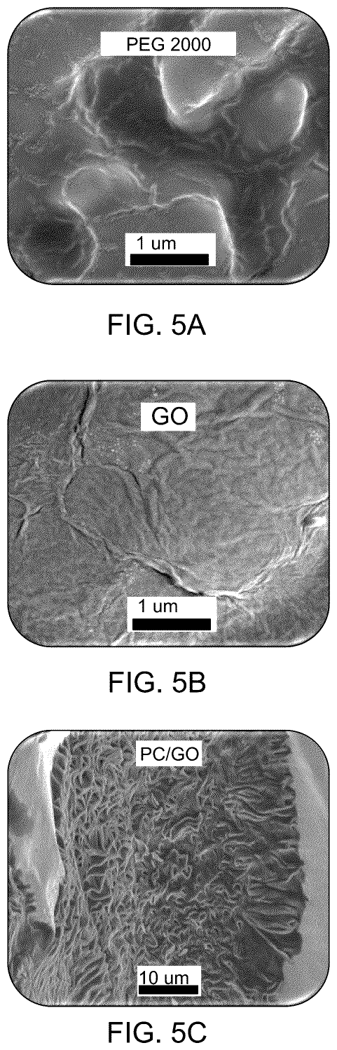

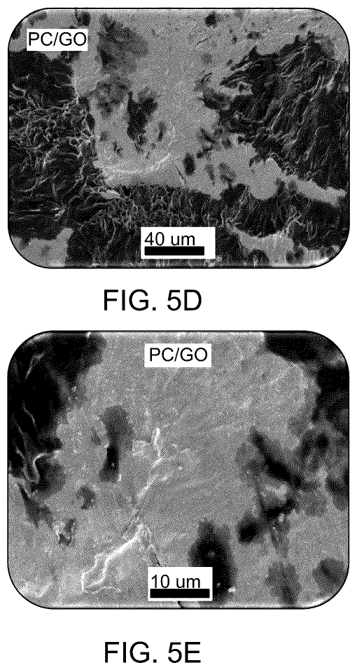

FIGS. 5A-5E show morphology images for the materials and the composite used in the present disclosure. In the PEG 2000 morphology, a smooth surface with minor deformation can be seen as the amount of PEG. Also, the morphology of graphene oxide, which has a 2D structure, is similar to a wrinkled layer. However, composite morphology reveals the existence of salt. A homogeneous composite mixture is visible where salt, polymer, and the carbon-based-material are all mixed.

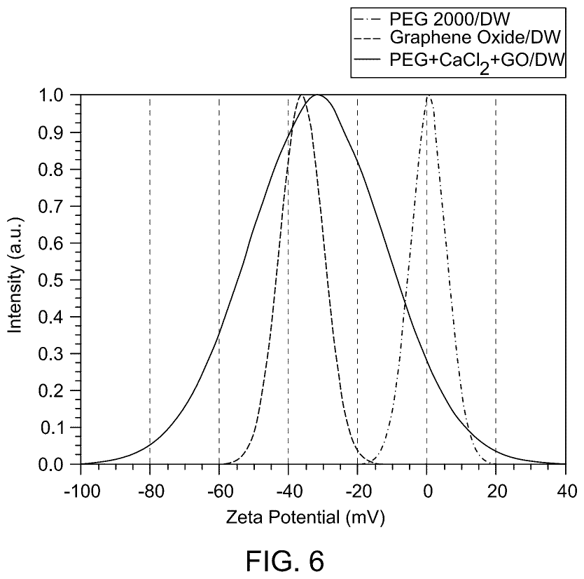

FIG. 6 shows ZP values for the materials and the composite used in the present disclosure. For PEG/distilled water, from −19 mV to +20 mV with the peak of 0.0 mV. For PEG, as zeta potential is defined as a potential associated with the interfacial charge density (i.e., surface charge between two phases), soluble polymers do not have an interface and do not have a zeta potential in a conventional sense. Thus, the ZP for PEG becomes zero. For GO/DW, ZP is from −59 mV to −13 mV with a peak of −36 mV. Also, for the composite/DW, ZP is from −100 mV to +42 mV with a peak of −32 mV. This value shows that the composite nanofluid has excellent stability (higher than 30).

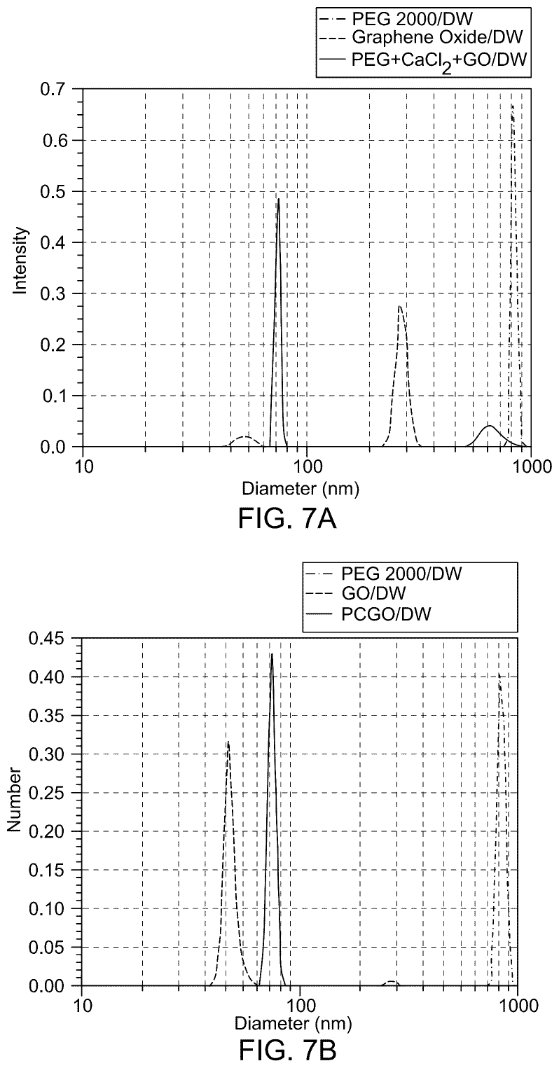

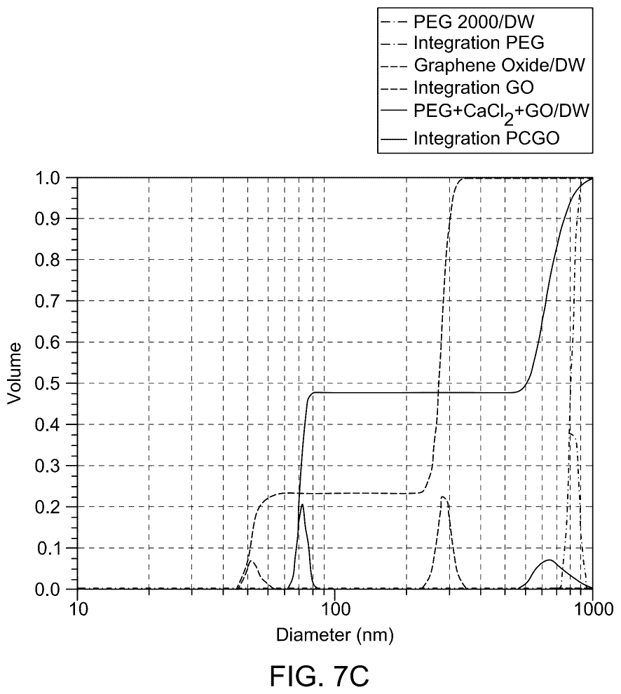

FIGS. 7A-7C show DLS values for materials and the composite used in the present disclosure. Distribution statistics for PEG/DW show that D intensity 10% is 831.149 nm, D intensity 50% is 831.149 nm, D intensity 90% is 870.48 nm, and thus, the mean intensity is 843.518 nm. D number 10% is 793.594 nm, D number 50% is 831.149 nm, D number 90% is 870.48 nm, and thus, the mean number is 845.955 nm. Therefore, D volume 10% is 793.594 nm, D volume 50% is 831.149 nm, D volume 90% is 911.674 nm, and thus, the mean volume is 850.222 nm.

Distribution statistics for GO/DW show that D intensity 10% is 59.58 nm, D intensity 50% is 261.62 nm, D intensity 90% is 286.967 nm, and thus, the mean intensity is 241.404 nm. D number 10% is 45.146 nm, D number 50% is 47.282 nm, D number 90% is 51.863 nm, and thus, the mean number is 52.433 nm. D volume 10% is 47.282 nm, D volume 50% is 261.62 nm, D volume 90% is 286.967 nm, and thus, the mean volume is 216.539 nm.

Distribution statistics for the composite/DW shows that D intensity 10% is 71.684 nm, D intensity 50% is 75.076 nm, D intensity 90% is 690.808 nm, and thus, the mean intensity is 219.792 nm. D number 10% is 71.684 nm, D number 50% is 75.076 nm, D number 90% is 78.629 nm, and thus, the mean number is 75.616 nm. D volume 10% is 71.684 nm, D volume 50% is 574.164 nm, D volume 90% is 793.594 nm, and thus, the mean volume is 407.375 nm. This proves that particle size distribution in nanofluid is in a good range, and there is no agglomeration.

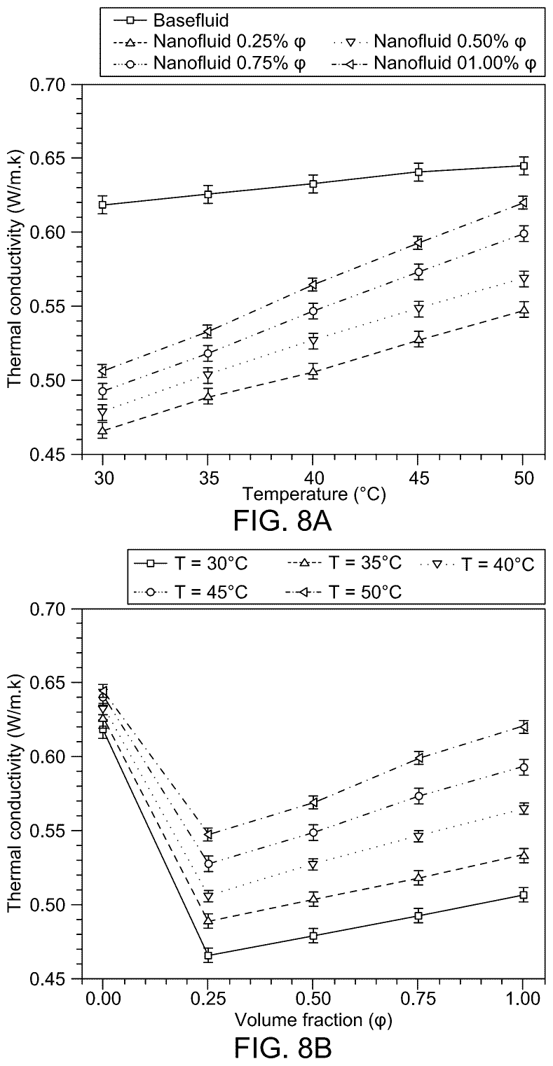

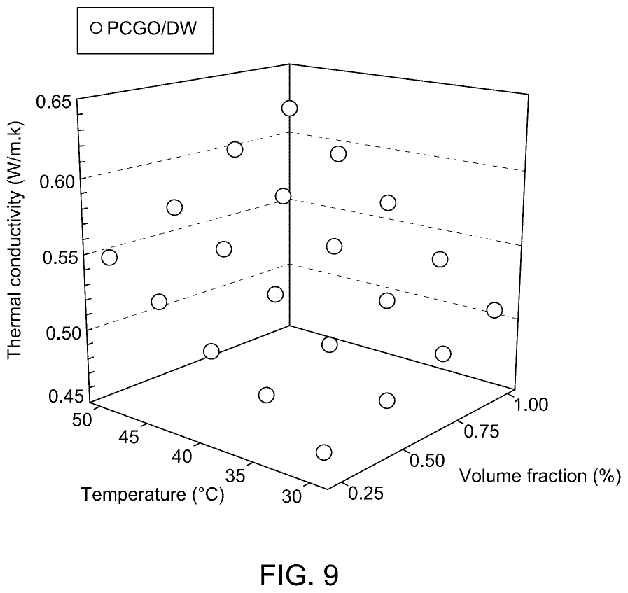

FIGS. 8A-8B and FIG. 9 show 2D and 3D plots, respectively, of composite nanofluid thermal conductivity by different volume fractions and temperatures. For temperatures of 30° C. and 50° C., thermal conductivities for 0.25, 0.50, 0.75, and 1.00 Vol. % samples are 0.46574-0.54756 W/m K, 0.47888-0.56943 W/m K, 0.49275-0.5994 W/m K, and 0.50662-0.62046 W/m K. For volume fractions of 0.25% and 1.00%, thermal conductivities for 30, 35, 40, 45, and 50° C. samples are 0.46574-0.50662 W/m K, 0.489-0.53325 W/m K, 0.50589-0.56518 W/m K, 0.52772-0.59329 W/m K, and 0.54756-0.62046 W/m K. Thus, by addition of graphene oxide, thermal conductivity of PEG is increased about 93.894%.

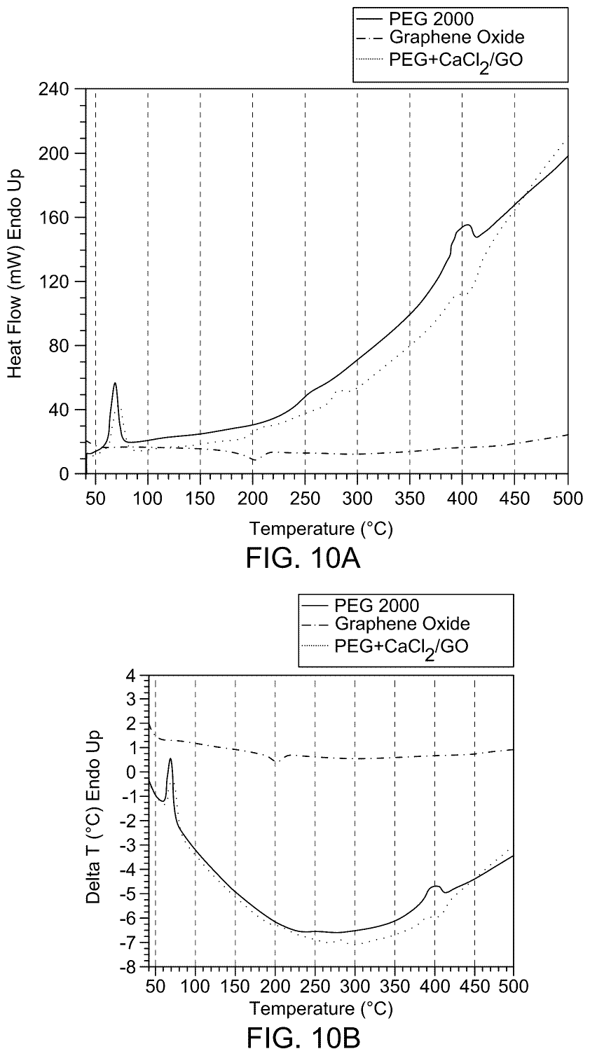

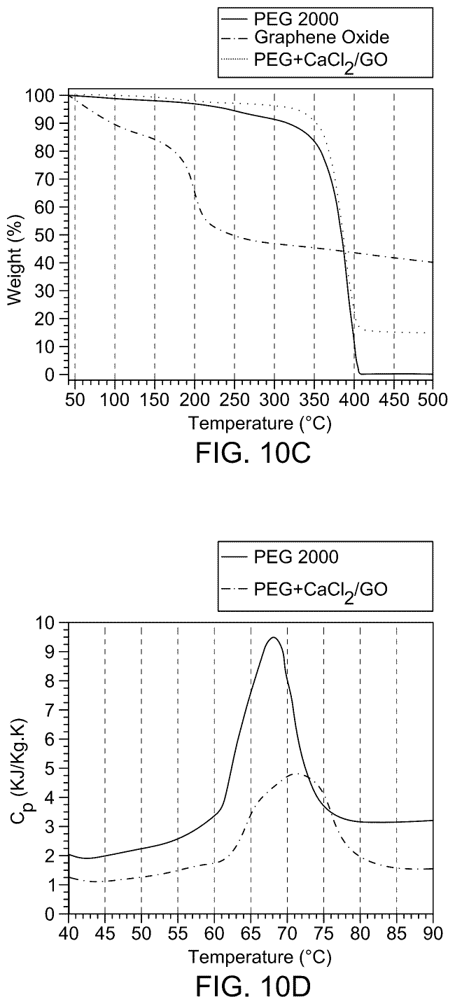

Differential Scanning Calorimetry (DSC), Differential thermal analysis (DTA), and Thermogravimetric analysis (TGA) were done at Argon atmosphere for neat PEG 2000, neat graphene oxide, and the PEG+CaCl₂/GO composite (FIGS. 10A-10D). In the DSC curve (FIG. 10A), with a heating rate of 5° C./min, for PEG, there are two endothermic peaks, one at 68.11° C. (57.68 mW), which refers to Tₘ, and another at 403.73° C. (154.96 mW). For GO, there is one exothermic peak at 202.44° C. (8.07 mW). For the composite, there are three endothermic peaks, one at 71.69° C. (42.81 mW), which refers to Tₘ, the second at 281.97° C. (51.64 mW), and another at 396.35° C. (111.25 mW). At the first endothermic peak, the PEG has an under-curve area of 269.77 with FWHM of 7.355, while the composite has an under-curve area of 301.61 with FWHM of 11.261. In the TGA curve (FIG. 10C), for PEG with sample mass of 22.057 mg, from 344.44° C. steep slope starts (84.96%), then at 359.57° C. steep slope becomes more intense (78.99%), and finally at 407.93° C. weight becomes zero. For GO with a sample mass of 1.530 mg, from 185.39° C. (75.68%) to 212.99° C. (55.11%) an intense steep slope appears. For the composite with sample mass of 32.155 mg, from 325.79° C. steep slope starts (94.67%), then at 356.38° C. steep slope becomes more intense (88.29%), and finally at 407.63° C. weight becomes 16.66%. The systematic way employed for calculating specific heat (Cₚ) was analogous to the standard technique defined by the American Society for Testing and Materials (ASTM) E1269-05.4. FIG. 10D shows the Cp based on sample weight at each temperature. As can be seen, due to the existence of calcium chloride, the temperature for the peak Cp is shifted to the right, which means the Cₚ is increasing. Thus, the effect of calcium chloride is positive in specific heat of PEG.

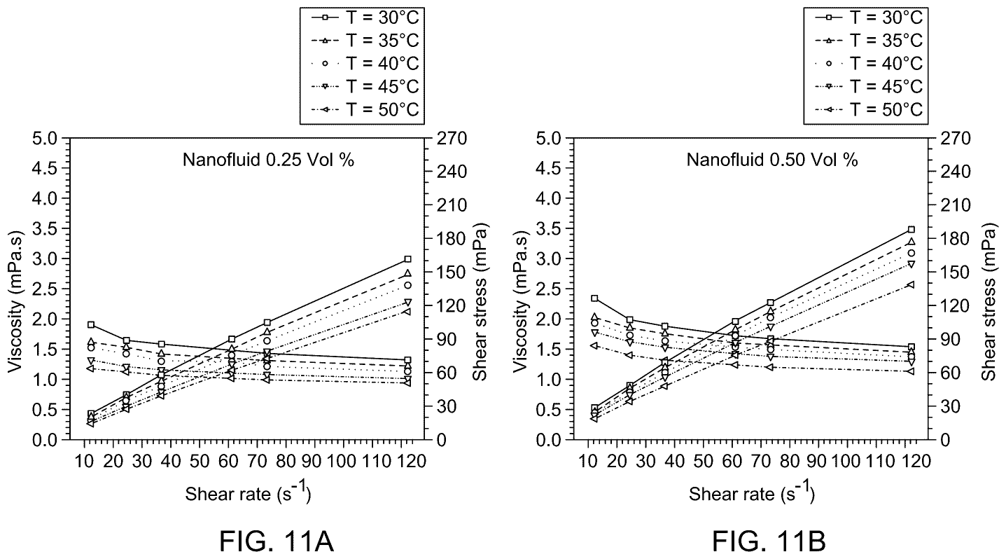

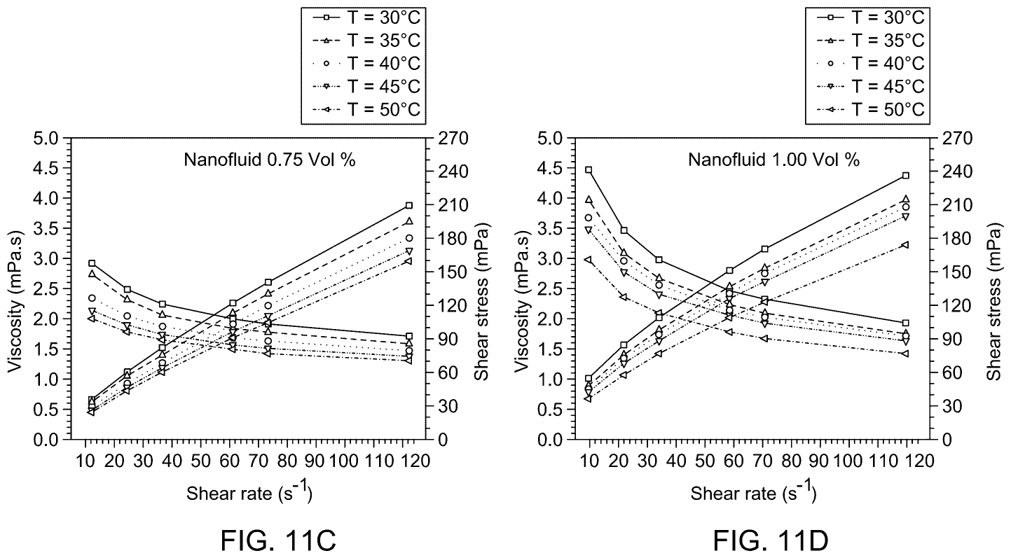

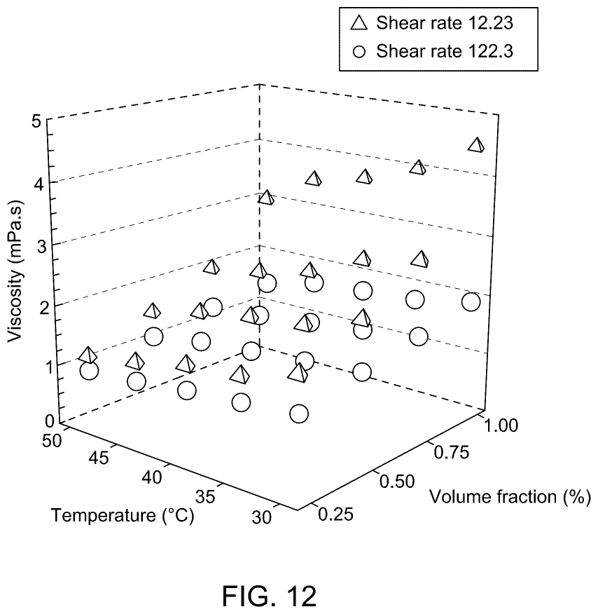

FIGS. 11A-11D show viscosity and shear stress of nanofluid at different temperatures and shear rates. FIG. 12 shows 3D plot for 12.23 and 122.3 s⁻¹ as beginning and last shear rates. For 30° C. and 50° C. of 0.25% nanofluid, in 12.23, 24.46, 36.69, 61.15, 73.38, and 122.3 s⁻¹, viscosity is 1.904-1.1748 mPa s, 1.6456-1.122 mPa s, 1.5776-1.0692 mPa s, 1.4688-1.0164 mPa s, 1.428-0.99 mPa s, 1.3192-0.9372 mPa s. For 30° C. and 50° C. of 1.00% nanofluid, in 12.23, 24.46, 36.69, 61.15, 73.38, and 122.3 s⁻¹, viscosity is 4.4744-2.9832 mPa s, 3.468-2.3628 mPa s, 2.9784-2.0988 mPa s, 2.4752-1.782 mPa s, 2.3256-1.6764 mPa s, 1.9312-1.4256 mPa s. Thus, shear stress of composite nanofluid shows non-newtonian rheological behavior.

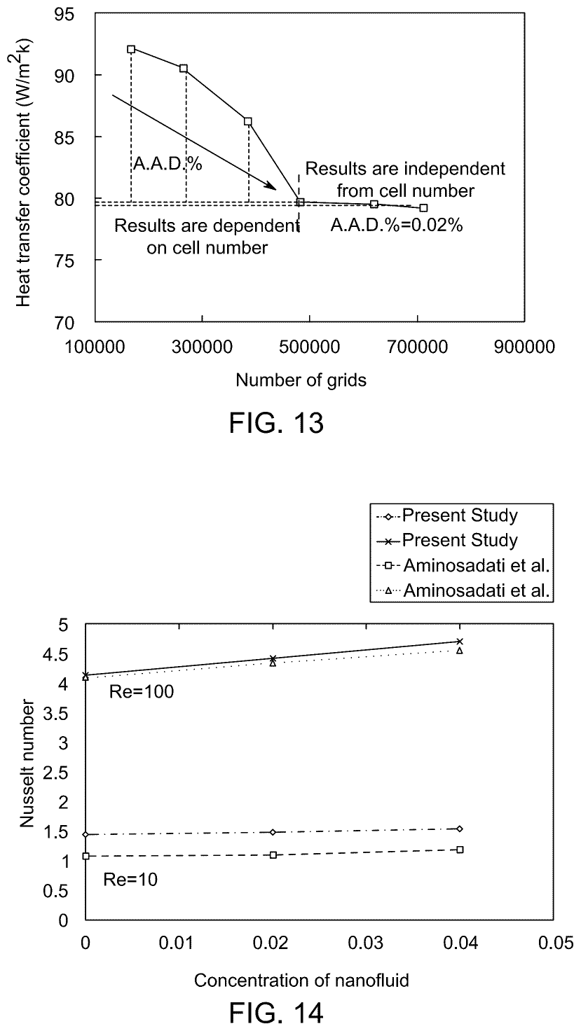

To ensure that results are independent of mesh and size, a grid independence analysis was conducted. As represented in FIG. 13, the heat transfer coefficient (HTC) variation with the mesh number in the mesh is depicted. The number of cells was changed from 160,000 to 720,000, while HTC value of the ribbed microchannel 100 was measured. The absolute average deviation (A.A.D.%) of the HTC data was monitored continuously until it satisfied A.A.D.%<0.01%.

FIG. 13 shows grid independence analysis for the HTC for various numbers of grids. Results showed that the HTC calculated with the model is consistent with 480,000 cells and higher. The trend showed that with an increase in a cell number to about 480,000 cells, there are no significant changes in the convective HTC. As a result, the cell number was used across all models as an optimum cell number.

FIG. 14 depicts a comparison between the results extracted from the literature from a study conducted by Aminossadati et al. [Aminossadati, S.; Raisi, A.; Ghasemi, B. Effects of magnetic field on nanofluid forced convection in a partially heated microchannel. International Journal of Non-Linear Mechanics 2011, 46, 1373-1382] and those obtained in the experiments present in this disclosure. This comparison was used to validate the models developed in the present research and to ensure that a correct solver and correct boundary conditions were applied to the problem.

The base case of comparison was dedicated to the Nusselt number within Reynolds numbers 10 and 100. However, as can be seen, regardless of the Reynolds number, the results are in good agreement with each other, showing that the model is reliable and the solver, boundary conditions, and the solution method are also reliable for the rest of the study. Notably, Aminossadati et al. conducted a series of studies on heat transfer in the conventional pipe with a uniform heat flux of 20,000 W/m² applied to the pipe's external surface. They also used alumina aqueous NF as a working fluid inside the pipe.

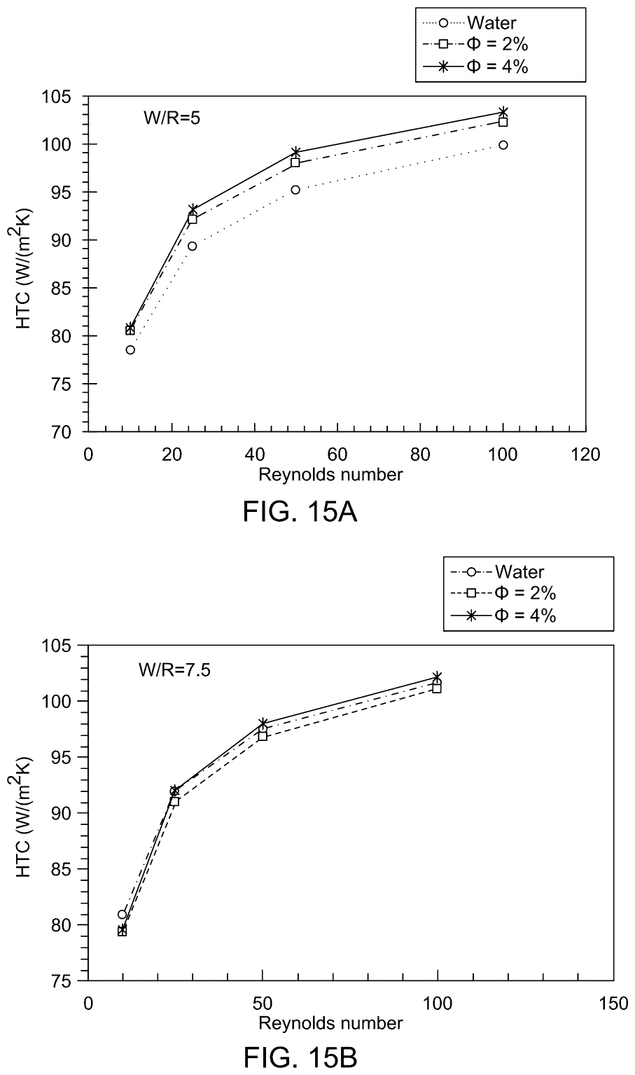

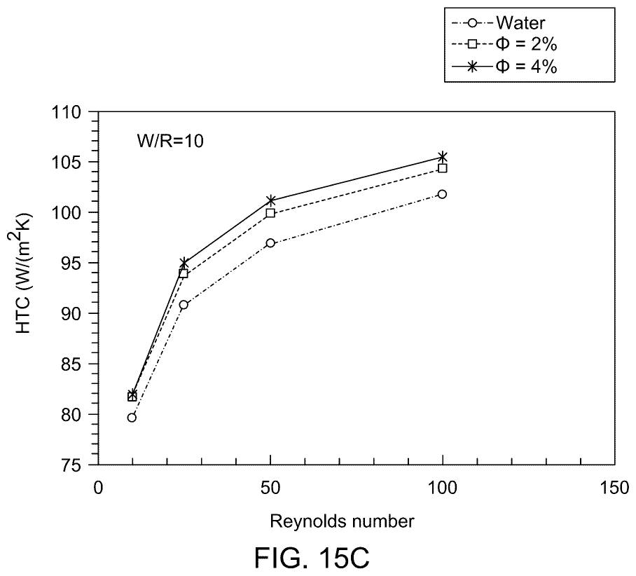

FIGS. 15A-15C show the heat transfer coefficient calculated for the ribbed microchannel 100 and three different W/R ratios. The inlet Reynolds number is 10, 25, 50, and 100, and a uniform heat flux of 10,000 W/m² was applied on the surface of the ribbed microchannel 100. As shown in FIGS. 15A-15C, with increasing the Reynolds number together with the concentration of the NFs, the convective HTC was increased. For all cases, the largest convective HTC belongs to the NF with the highest concentration. This is due to the presence of nanoparticles, which increased the thermal conductivity of the base fluid and promoted the conductive fluxes and better heat transfer within the base fluid.

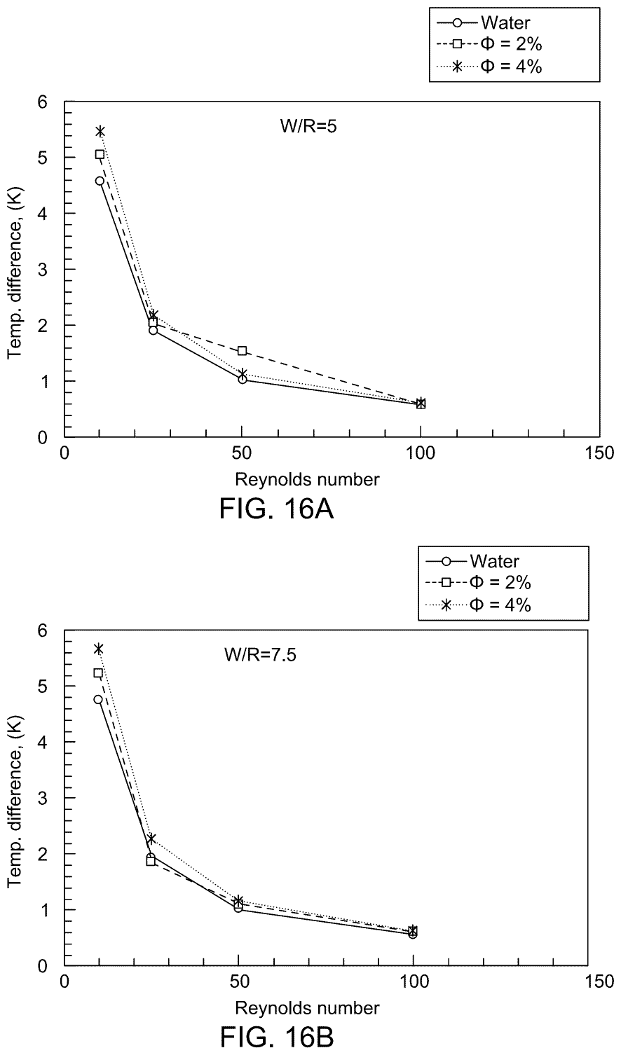

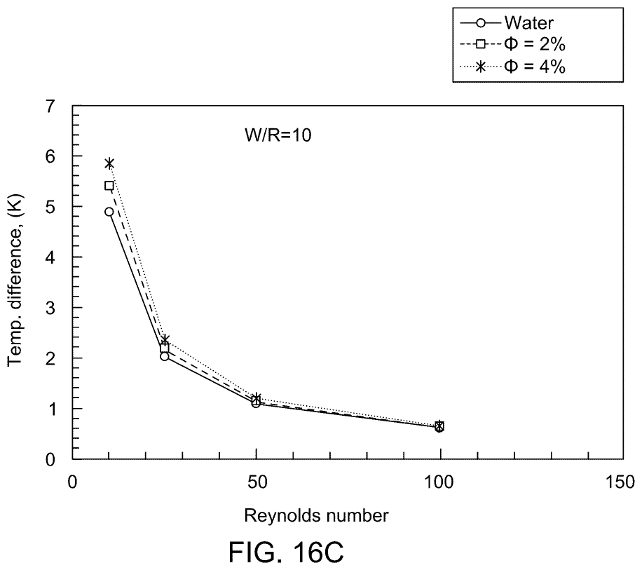

As depicted in FIGS. 16A-16C, the optimum W/R ratio was 5, in which the highest HTC was observed. By increasing the W/R ratio, the HTC decreased due to a reduction in the hydraulic space for flow to pass through the ribbed microchannel 100.

FIGS. 16A-16C show the variations of the temperature difference between the inlet and outlet of the ribbed microchannel 100 at different W/R ratios and concentrations. In a low Reynolds number, the maximum temperature difference of ˜6 K was obtained belonging to the NF with the highest concentration of 4%. Thus, it is justifiable to form vortices, local agitation behind the radial ribs 110, and more significant flow separation. At a higher Reynolds number, the fluid flow suppressed the formation of vortices. However, instead, it applies more momentum to the system, which creates a lower temperature difference as velocity and flow rate are high.

On the other hand, by flowing the fluid through the ribbed microchannel 100 with higher W/R ratios, the heat transfer is more prominent, while there is a penalty to be paid for the pressure loss due to the more considerable momentum induced into the ribbed microchannel 100. An increase in the W/R ratio influenced the temperature difference between the inlet and outlet for all Reynolds numbers. Overall, W/R ratio is a crucial design parameter affecting the thermal performance of the ribbed microchannel 100.

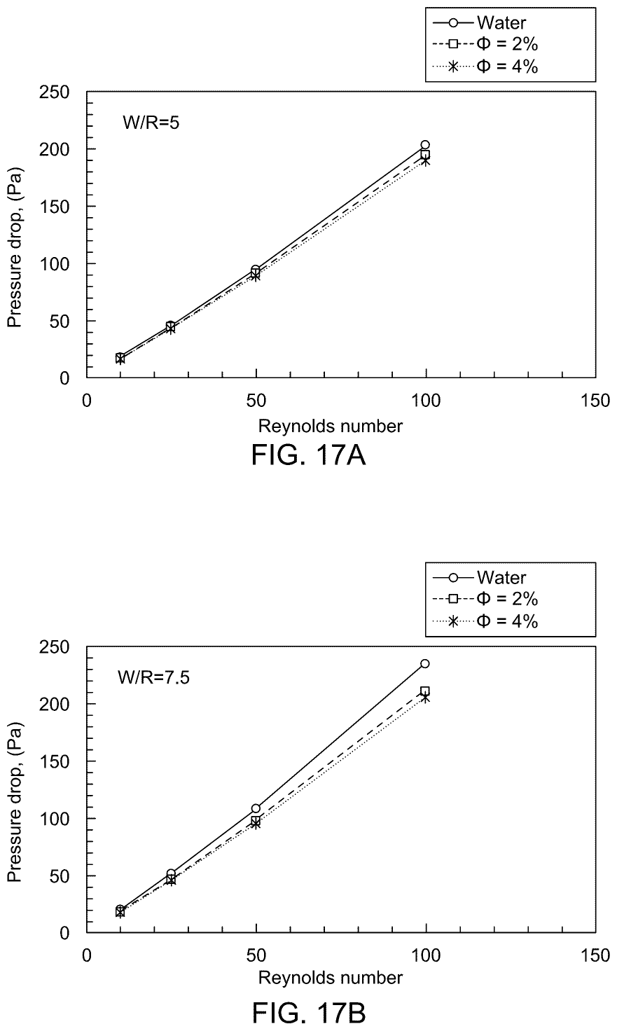

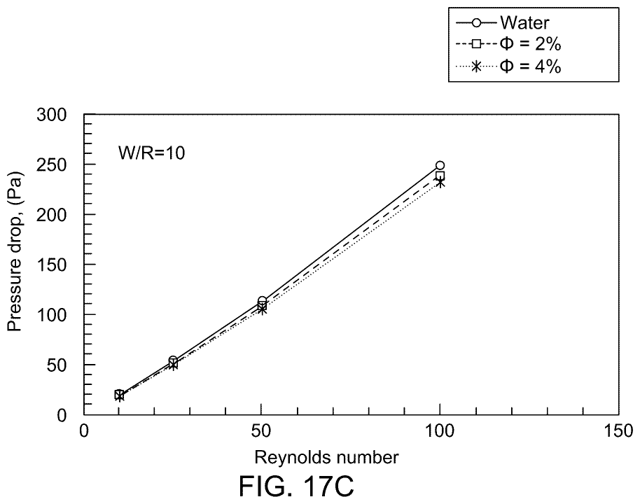

FIGS. 17A-17C show the pressure losses at different concentrations and Reynolds number at various W/R ratios. For all the ratios, regardless of the NF concentration, it can be observed that the PD increases with increasing Reynolds number. However, the most considerable PD value was obtained for the NF with a concentration of 4%. Also, by increasing the W/R ratio, as hydraulic space for the liquid decreases, a more extensive PD is induced into the system such that the highest PD value measured in the experiments belongs to W/R=10. The presence of nanoparticles increases the viscosity and hence friction forces within the system, increasing the friction factor and the PD value.

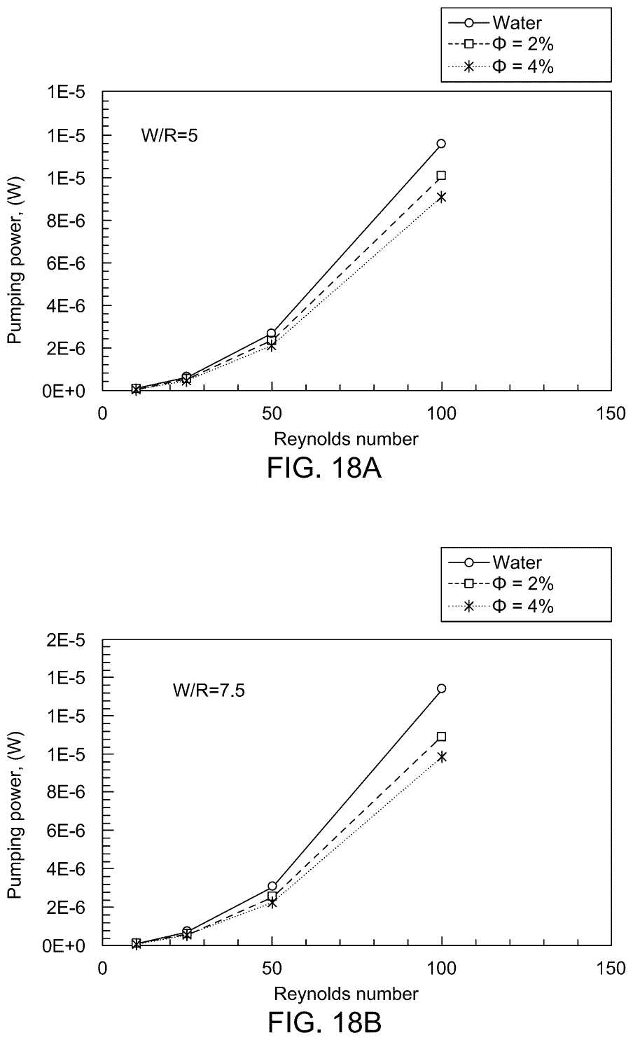

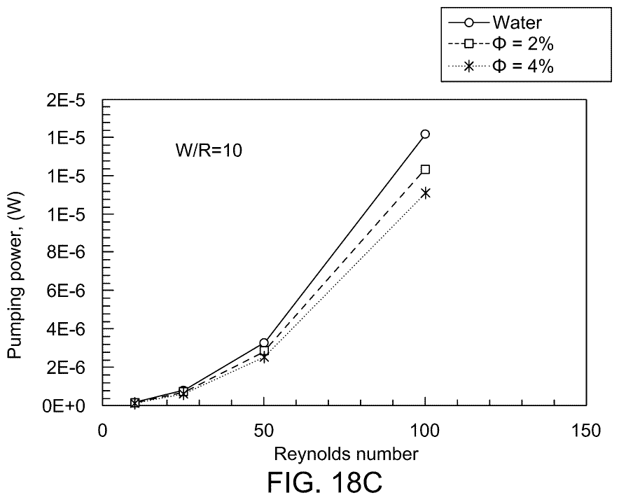

FIGS. 18A-18C depict the variations of the calculated pumping powers with Reynolds number for the base fluid and two different concentrations of the NFs. As shown, at low Reynolds number, the effect of W/R ratio on the pumping power is not significant, while, with increasing velocity, the higher PD is induced into the cross-sectional area between the radial rib 110 and the microchannel wall, which adds to the pumping power of the system. Particularly, increasing the hydrodynamic forces along with the flow direction requires higher pumping power. Hence, as observed, more considerable pumping power was calculated by increasing the fluid flow regardless of the NF concentration. Likewise, increasing the concentration of the NF contributes to the augmentation of the pumping power due to the enhancement in the friction forces, augmentation of the PD and as a result, increase in the PD of the system. Also, by increasing the W/R ratio, the pumping power reduces due to enlarging the hydraulic space available for flow. The maximum pumping power was recorded for W/R=10. It is worth mentioning that increasing the density of NF results in augmentation of the PD value, as well.

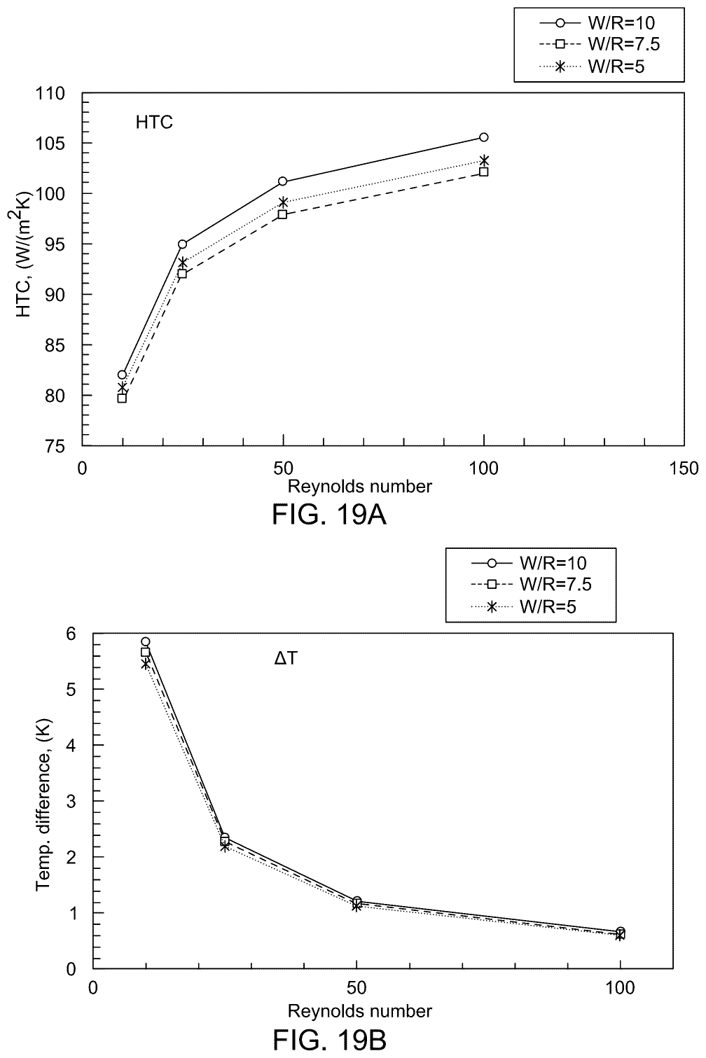

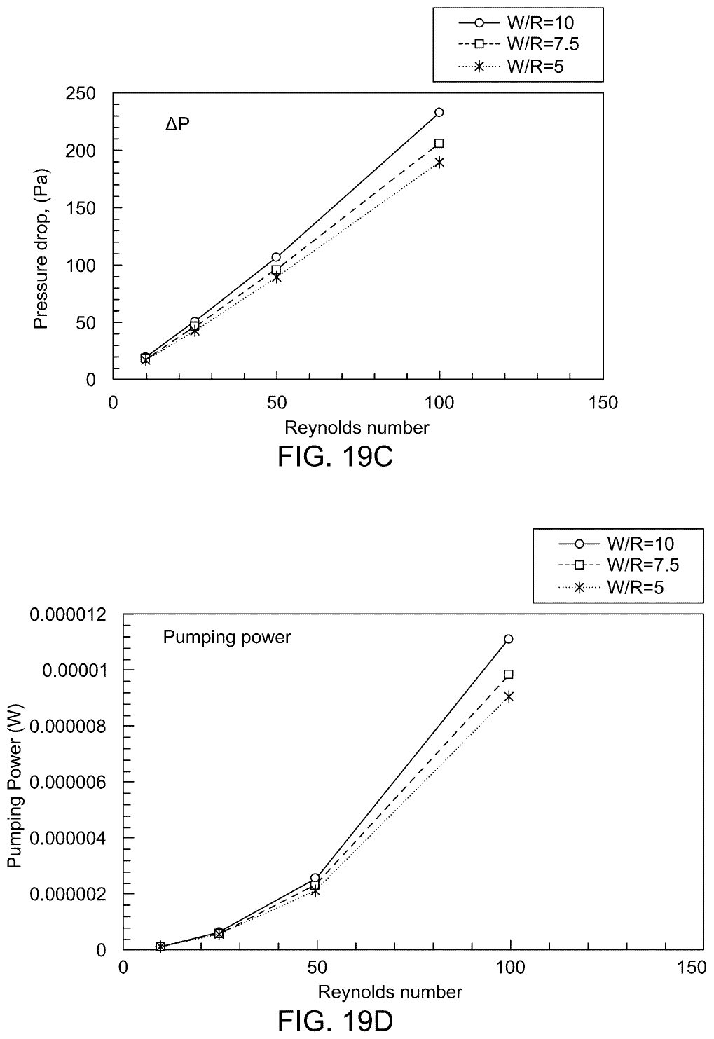

In FIGS. 19A-19D, at the same concentration of NF (vol. %=4), the effect of W/R ratio on the HTC, temperature difference, PD, and pumping power of the system is investigated and discussed. As shown in FIG. 19A, at higher W/R ratios, the hydrodynamic forces overcome the viscous forces, and as a result, the convective HTC is promoted. Also, the variations in all three figures have the same trends. The effect of Brownian motion forces on the heat transfer propagation should also be considered, although the current modeling approach does not support the Brownian motion, promoting the HTC across microchannel. The temperature difference for various ratios of W/R at the same condition is given in FIG. 19B. As can be seen from the figure, all plots have the same trends. By increasing the Reynolds number in the ribbed microchannel 100, the fluid has less residence time for heat transfer. For the ratio of W/R=5, the convective HTC reached its lowest value. A comparison of heat transfer at various W/R ratios showed that at W/R=10, the maximum convective HTC was recorded. The PD at W/R=2.5 and Re=100 was 178 Pa, while it was 243 Pa at W/R=10 for the same condition. By increasing the Reynolds number and the W/R ratio, the PD increased (see FIG. 19C), which results in the augmentation in the pumping power, as shown in FIG. 19D.

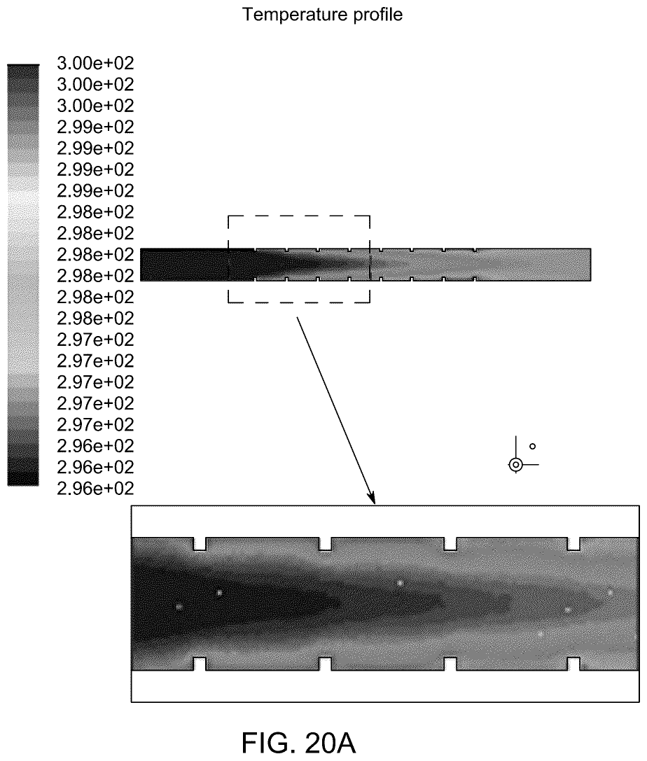

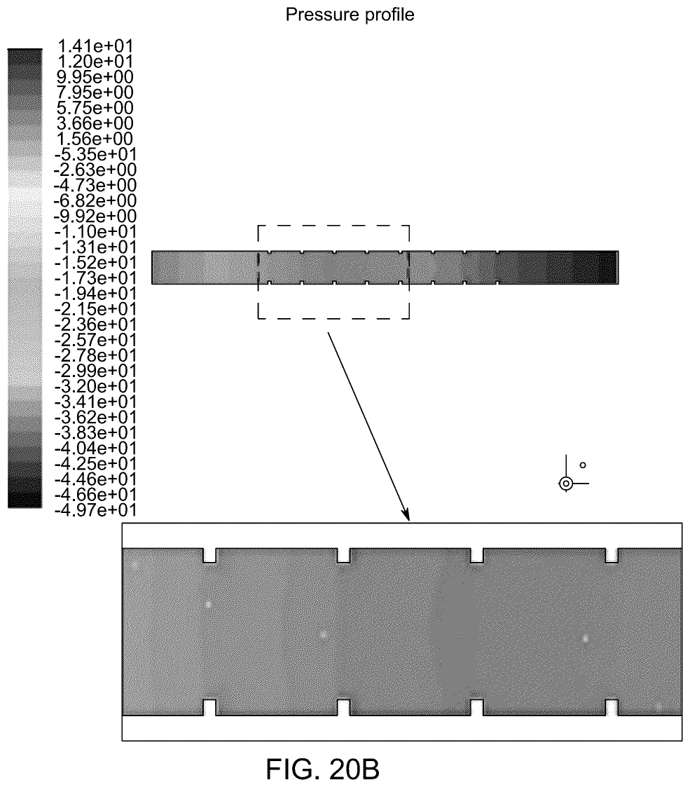

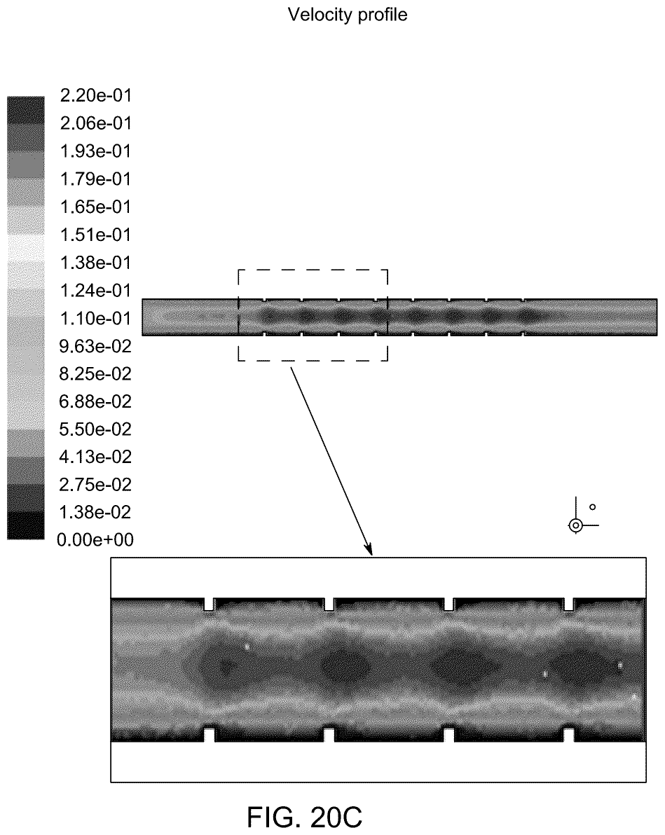

FIGS. 20A-20C depict the calculated spatial temperature, pressure, and velocity profile across the ribbed microchannel 100 length at Re=25. The spatial temperature profile in FIG. 20A shows that the temperature behind the radial ribs 110 and obstacles is constant. This indicates that the flow is relatively stagnant, while convective heat transfer is minimum. This is because the velocity of the fluid is minimal in the regions behind the radial ribs 110. This can be confirmed further in FIGS. 20B and 20C, where fluid pressure and velocity are also slight. In addition, the pressure is negative, which shows the potential formation of vortices behind the radial ribs 110. From all figures, it can be concluded that the radial ribs 110 do not change the flow uniformity, and the flow stays in the laminar regime despite any potential vortices that might form behind the obstacles.

The composite phase change material, according to the present disclosure, has good stability with a Zeta potential of −32 mV, an improved thermal conductivity of 93.894% compared to PEG polymer, a specific heat capacity of 4.79 kJ/kg K at 71.3° C., non-Newtonian rheological behavior with enhanced viscosity of 174.503% compared to the PEG polymer, and morphological stability during phase change. Moreover, the composite helps form sheets having thermal energy storage characteristics.

According to the present disclosure, the radial ribs 110 and the fins provided on the ribbed microchannel 100 disrupt the thermal and mass transfer boundary layers, which considerably increases the efficiency of the microchannel compact heat exchanging system compared with other known systems. Further, the first plenum 106 and the second plenum 108 of the ribbed microchannel 100 provide laminar fluid flow in the microchannel compact heat exchanging system to avoid a considerable pressure drop value due to the turbulent flow regime. With the ribbed microchannel 100 of the present disclosure, thermo-hydraulic performance index of the microchannel compact heat exchanging system is improved to 1.88-2.1, which is 30-50% more effective than other known systems. The microchannel compact heat exchanging system of the present disclosure is flexible to various applications and can be used as a micro-cooler, micro-heater, solar thermal receiver, micro-reactor, and micro-mixer by modifications in the hydraulic diameter and fabrication material. Internal area of the microchannel compact heat exchanging system can be coated with nano-catalyst in the micro catalytic reactor. The fin intensifies the transport phenomena inside the microchannel compact heat exchanging system, compensating for reducing the performance of the system due to the friction forces between working fluids and the coating layer. The microchannel compact heat exchanging system of the present disclosure has a relatively low-pressure drop, and the pressure drop does not affect the performance of the microchannel compact heat exchanging system.

In an implementation, a techno-economic assessment to use the ribbed microchannel 100 for hydrogen production is performed. For example, a current target price for hydrogen production is 2.12 $/kg of hydrogen using electrolysis and 2.83 $/kg of H₂ using thermochemical processes. However, using the ribbed microchannel 100 of the present disclosure using solar energy and fabrication material of zinc and copper oxide, the projected cost of hydrogen production can be reduced to ˜1.42 $/kg of H₂. Further, the microchannel compact heat exchanging system of the present disclosure can be scaled up quickly as it is a modular device. The fabrication procedure is available, fast, and low-cost, and it can be made from most of the available industrial solid materials in the world. It is also a 100% mechanical device with no moving parts. Due to the used plenums in the design, the flow is always laminar, and therefore, erosion or corrosion will not happen in the device.

Obviously, numerous modifications and variations of the present disclosure are possible in light of the above teachings. It is therefore to be understood that within the scope of the appended claims, the invention may be practiced otherwise than as specifically described herein.

What is claimed is:

1. A microchannel compact heat exchanging system, comprising:
a ribbed microchannel including a plurality of radial ribs and fins, a ratio between a thickness of each radial rib and a radius of the ribbed microchannel being within a first predefined range,
a water-based nanofluid in the ribbed microchannel comprising polyethylene glycol (PEG), calcium chloride, and a graphene oxide carbon-based material; and
two plenums connected to the ribbed microchannel.

2. The microchannel compact heat exchanging system of claim 1, wherein the first predefined range is from 5 to 10.

3. The microchannel compact heat exchanging system of claim 2, wherein the thickness of each radial rib is from 0.1 mm to 1 mm and the radius of the ribbed microchannel is from 0.05 mm to 0.1 mm.

4. The microchannel compact heat exchanging system of claim 1, wherein a length of each of the two plenums is from 0.1 m to 2 m.

5. The microchannel compact heat exchanging system of claim 1, wherein a distance between two adjacent radial ribs is from 0.01 mm to 0.1 mm.

6. The microchannel compact heat exchanging system of claim 1, wherein a number of the plurality of radial ribs is 7.

7. The microchannel compact heat exchanging system of claim 1, wherein the water-based nanofluid is prepared by preparing a solution by dispersing the PEG and the calcium chloride into water at 25° C. until the PEG and the calcium chloride reach saturation and by dispersing the graphene oxide carbon-based material into the solution, a volume fraction of the graphene oxide in the solution being within a second predefined range.

8. The microchannel compact heat exchanging system of claim 7, wherein the second predefined range is from 0.25% to 1.0%.

9. The microchannel compact heat exchanging system of claim 7, wherein the water-based nanofluid is stirred for a first time period and processed for a second time period using an ultrasonic signal.

10. The microchannel compact heat exchanging system of claim 9, wherein the first and the second time periods are from 5 mins to 60 mins.

11. The microchannel compact heat exchanging system of claim 9, wherein a power and a frequency of the ultrasonic signal are 400 W and 24 kHz, respectively.

12. The microchannel compact heat exchanging system of claim 1, wherein the water-based nanofluid further comprises carboxymethyl cellulose.

13. The microchannel compact heat exchanging system of claim 1, wherein the two plenums provide a laminar fluid flow in the ribbed microchannel.

14. A micro catalytic reactor, comprising:
a ribbed microchannel including a plurality of radial ribs and fins, an internal surface of the ribbed microchannel being coated with a nano-catalyst, and a ratio between a thickness of each radial rib and a radius of the ribbed microchannel being within a range from 5 to 10; and
two plenums connected to the ribbed microchannel.

15. A method of preparing a water-based nanofluid, the method comprising:
preparing a solution by dispersing polyethylene glycol (PEG) and calcium chloride into water at 25° C. until the PEG and the calcium chloride reach saturation; and
dispersing a graphene oxide carbon-based material into the solution to form the water-based nanofluid, a volume fraction of the graphene oxide in the solution being within a predefined range.

16. The method of claim 15, wherein the predefined range is from 0.25% to 1.0%.

17. The method of claim 15, further comprising:
stirring the water-based nanofluid for a first time period; and
processing the water-based nanofluid for a second time period using an ultrasonic signal.

18. The method of claim 17, wherein the first and the second time periods are from 5 mins to 60 mins.

19. The method of claim 17, wherein a power and a frequency of the ultrasonic signal are 400 W and 24 kHz, respectively.

20. The method of claim 15, further comprising:
preparing the water-based nanofluid with carboxymethyl cellulose.
